(19) United States
(12) Patent Application Publication
(10) Pub. No.: US 2012/0324880 A1
(43) Pub. Date: Dec. 27, 2012

(54) ELECTRIC-HYDRAULIC HYBRID DRIVER

(76) Inventors: Norihiro Kuzuu, Tokyo (JP); Kenta Miyazaki, Tokyo (JP); Yukio Imai, Tokyo (JP); Toshiharu Kubota, Tokyo (JP)

(21) Appl. No.: 13/521,098

(22) PCT Filed: Jun. 23, 2011
(86) PCT No.: PCT/JP2011/064454

§ 371 Date: Jul. 9, 2012

(51) Int. Cl. F15B 1/02

(52) U.S. Cl. 60/413

(57) ABSTRACT

The present invention provides an apparatus for electrically and hydraulically driving a hydraulic cylinder, including a hydraulic pump rotatable in opposite directions, an electric motor for driving the hydraulic pump, a reservoir tank containing hydraulic fluid therein, and a servo-valve. The hydraulic cylinder makes fluid-communication at a head-sided hydraulic chamber with a first port of the hydraulic pump, and makes fluid-communication at a rod-sided hydraulic chamber with a second port of the hydraulic pump. The servo-valve allows ones of the head-sided hydraulic chamber and the rod-sided hydraulic chamber to make fluid-communication to the reservoir tank in accordance with a direction in which the hydraulic pump rotates, and varies a degree at which one of the head-sided hydraulic chamber and the rod-sided hydraulic chamber makes fluid-communication with the reservoir tank, to a designated degree.

### FIELD OF THE INVENTION

The invention relates to an electric-hydraulic hybrid apparatus for driving a hydraulic cylinder in accordance with a hydraulic pressure of hydraulic fluid discharged out of a hydraulic pump driven by an electric motor.

### BACKGROUND ART

FIG. 22 is a block diagram illustrating a structure of a conventional electric-hydraulic hybrid driver.

The conventional electric-hydraulic hybrid driver 1000 illustrated in FIG. 22 includes an electric motor 1100, a hydraulic pump 1200 driven for rotation in opposite directions by the electric motor 1100, a head-sided flow path 1300 through which a single-rod type hydraulic cylinder 5000 makes fluid-communication at a head-sided hydraulic chamber 510A thereof with the hydraulic pump 1200, a rod-sided flow path 1400 through which the single-rod type hydraulic cylinder 5000 makes fluid-communication at a rod-sided hydraulic chamber 510B thereof with the hydraulic pump 1200, a tank 1500 in which hydraulic fluid is reserved, a first flow path 1510 through which the head-sided flow path 1300 makes fluid-communication with the tank 1500, a second flow path 1520 through which the rod-sided flow path 1400 makes fluid-communication with the tank 1500, a first pilot check valve 1610 situated in the first flow path 1510, and a second pilot check valve 1620 situated in the second flow path 1520.

The first pilot check valve 1610 allows hydraulic fluid to flow into the head-sided flow path 1300 from the tank 1500. The first pilot check valve 1610 introduces thereinto a hydraulic pressure of the rod-sided flow path 1400, and, opens when the hydraulic pressure of the rod-sided flow path 1400 exceeds a threshold pressure, to thereby allow the head-sided flow path 1300 and the tank 1500 to make fluid-communication with each other.

Similarly, the second pilot check valve 1620 allows hydraulic fluid to flow into the rod-sided flow path 1400 from the tank 1500. The second pilot check valve 1620 introduces thereinto a hydraulic pressure of the head-sided flow path 13400, and, opens when the hydraulic pressure of the head-sided flow path 1300 exceeds a threshold pressure, to thereby allow the rod-sided flow path 1400 and the tank 1500 to make fluid-communication with each other.

In general, in an electric-hydraulic hybrid driver, since a volume of a rod 5030 existing in the cylinder 5010 varies as a cylinder 5010 moves, it is necessary to control flow rates of the head-sided hydraulic chamber 5010A and the rod hydraulic chamber 5010B accordingly. In the electric-hydraulic hybrid driver 1000, the flow rates are controlled by controlling opening and closing of the first pilot check valve 1610 and the second pilot check valve 1620.

The hydraulic cylinder 5000 includes a cylinder 5010, a piston 5020 slidable along an inner wall of the cylinder 5010, and a rod 5030 connected to the piston 5020.

The rod 5030 makes contact at a distal end thereof with a load 5040.

Causing the hydraulic pump 1200 to rotate in a forward direction by means of the electric motor 1100, hydraulic fluid is absorbed into the hydraulic pump 1200 from the rod-sided hydraulic chamber 5010B of the cylinder 5010 through the rod-sided flow path 1400, and then, discharged into the head-sided hydraulic chamber 5010A of the cylinder 5010 through the head-sided flow path 1300. The second pilot check valve 1620 is open by virtue of a pilot pressure introduced from the head-sided flow path 1300, and resultingly, hydraulic fluid is supplemented into the rod-sided flow path 1400 from the tank 1500.

As a result that hydraulic fluid is discharged into the head-sided hydraulic chamber 5010A of the cylinder 5010, the rod 5030 is pushed towards the right X2 in FIG. 22 to thereby push the load 5040 to the right X2.

Causing the hydraulic pump 1200 to rotate in a backward direction by means of the electric motor 1100, hydraulic fluid is absorbed into the hydraulic pump 1200 from the head-sided hydraulic chamber 5010A of the cylinder 5010 through the head-sided flow path 1300, and then, discharged into the rod-sided hydraulic chamber 5010B of the cylinder 5010 through the rod-sided flow path 1400. The first pilot check valve 1610 is open by virtue of a pilot pressure introduced from the rod-sided flow path 1400, and resultingly, extra hydraulic fluid is discharged into the tank 1500 from the head-sided flow path 1300.

As a result that hydraulic fluid is discharged into the rod-sided hydraulic chamber 5010B of the cylinder 5010, the rod 5030 moves to the left X1 in FIG. 22.

In the head-sided hydraulic chamber 5010A and the rod-sided hydraulic chamber 5010B of the cylinder 5010, there occurs overs and shorts of hydraulic fluid in accordance with a volume of the rod 5030. Consequently, the conventional electric-hydraulic hybrid driver 1000 illustrated in FIG. 22 is designed to discharge extra hydraulic fluid into the tank 1500 through the first pilot check valve 1610, or supplement hydraulic fluid from the tank 1500 through the second pilot check valve 1620 for compensate for a shortage, thereby controlling overs and shorts of hydraulic fluid in accordance with a volume of the rod 5030.

However, the conventional electric-hydraulic hybrid driver 1000 illustrated in FIG. 22 is accompanied with a problem that since there occurs high fluctuation in pressure when the first and second pilot check valves 1610 and 1620 are open or closed, the pressure balance is broken with the result of occurrence of hunting.

In order to solve this problem, Japanese Patent Application Publication No. 10 (1998)-78003 has suggested an electric-hydraulic hybrid driver, as illustrated in FIG. 23.

The electric-hydraulic hybrid driver 2000 illustrated in FIG. 23 is designed to include, in comparison with the electric-hydraulic hybrid driver 1000 illustrated in FIG. 22, a head-sided electromagnetic valve 2100 and a rod-sided electromagnetic valve 2200 in place of the first pilot check valve 1610 and the second pilot check valve 1620, respectively.

The head-sided electromagnetic valve 2100 is designed to take a fluid-communication position 2100A, on receipt of excitation signals, at which the head-sided flow path 1300 and the tank 1500 make fluid-communication with each other, and a shut-off position 2100B, on receipt of no excitation signals, at which the head-sided flow path 1300 and the tank 1500 are shut off with each other.

The rod-sided electromagnetic valve 2200 is designed to take a fluid-communication position 2200A, on receipt of excitation signals, at which the rod-sided flow path 1400 and the tank 1500 make fluid-communication with each other, and a shut-off position 2200B, on receipt of no excitation signals, at which the rod-sided flow path 1400 and the tank 1500 are shut off with each other.

The electric-hydraulic hybrid driver 2000 is said to be able to prevent occurrence of hunting by including the head-sided electromagnetic valve 2100 and the rod-sided electromagnetic valve 2200.

### PRIOR ART DOCUMENTS

### Patent Documents

Patent document 1: Japanese Patent Application Publication No. 10 (1998)-78003

### DISCLOSURE OF THE INVENTION

### Problems to be Solved by the Invention

However, the conventional electric-hydraulic hybrid driver 2000 illustrated in FIG. 23 is accompanied with the following problems.

The first problem is that the electric-hydraulic hybrid driver 2000 has a long response-delay time defined as a time having passed after the driver receives a start signal until the driver actually starts its operation.

The conventional electric-hydraulic hybrid driver 2000 illustrated in FIG. 23 is not able to control a difference in a flow rate of hydraulic fluid between the head-sided hydraulic chamber 5010A and the rod-sided hydraulic chamber 5010B until the head-sided electromagnetic valve 2100 or the rod-sided electromagnetic valve 2200 is open or closed. Furthermore, a speed at which opening and closing of the head-sided electromagnetic valve 2100 and the rod-sided electromagnetic valve 2200 is switched is low. Thus, a response-delay time cannot avoid from being high until the electric-hydraulic hybrid driver 2000 actually starts its operation, and resultingly, the electric-hydraulic hybrid driver 2000 has low response performance.

The second problem is that it is not possible to control a flow rate of hydraulic fluid to a desired flow rate.

Since the control to the head-sided electromagnetic valve 2100 and the rod-sided electromagnetic valve 2200 in the electric-hydraulic hybrid driver 2000 is on-off control, a flow path through which hydraulic fluid flows can be two flow paths formed when the head-sided electromagnetic valve 2100 or the rod-sided electromagnetic valve 2200 is on or off. Thus, it was impossible to control a flow rate of hydraulic fluid such that the flow rate continuously varies.

The third problem is that though occurrence of hunting can be reduced, it is not possible to completely prevent occurrence of hunting.

Since the control to the head-sided electromagnetic valve 2100 and the rod-sided electromagnetic valve 2200 in the electric-hydraulic hybrid driver 2000 is on-off control, pressure fluctuation resulted from opening and closing of the valves is still high, and hence, a frequency at which hunting occurs is reduced in comparison with the electric-hydraulic hybrid driver 1000 illustrated in FIG. 22, but it is not possible to completely prevent occurrence of hunting. In particular, when the hydraulic cylinder 5000 is accelerated or when the load 5040 is high, hunting is still easy to occur.

The fourth problem is that heat is easy to generate and cavitation is easy to occur.

Due to the above-mentioned response-delay time and hunting, the electric motor 1100 generates a torque more than necessary, and resultingly, hydraulic fluid is repeatedly excessively pressurized and depressurized. This results in that there occur heat dissipation from the electric motor 1100 and cavitation in the hydraulic pump 1200.

In view of the above-mentioned problems in the conventional electric-hydraulic hybrid driver, it is an object of the present invention to provide an electric-hydraulic hybrid driver which is capable of solving the above-mentioned problems.

### Solution to the Problems

In order to accomplish the above-mentioned object, the present invention provides an apparatus for electrically and hydraulically driving a hydraulic cylinder, including a hydraulic pump rotatable in opposite directions, an electric motor for driving the hydraulic pump, a reservoir tank containing hydraulic fluid therein, and a servo-valve, wherein the hydraulic cylinder makes fluid-communication at a head-sided hydraulic chamber with one of an inlet and an outlet of the hydraulic pump, and makes fluid-communication at a rod-sided hydraulic chamber with the other, the servo-valve allows ones of the head-sided hydraulic chamber and the rod-sided hydraulic chamber to make fluid-communication to the reservoir tank in accordance with a direction in which the hydraulic pump rotates, and the servo-valve varies a degree at which one of the head-sided hydraulic chamber and the rod-sided hydraulic chamber makes fluid-communication with the reservoir tank, to a designated degree.

For instance, the servo-valve may be designed to include a sleeve formed with a through-hole, and a spool slidable through an inner wall of the through-hole, in which case, it is preferable that the sleeve is formed with a first sleeve through-hole through which the head-sided hydraulic chamber of the hydraulic cylinder makes fluid-communication with one of the inlet and the outlet of the hydraulic pump, a second sleeve through-hole through which the rod-sided hydraulic chamber of the hydraulic cylinder makes fluid-communication with the other, and a third sleeve hole through which the through-hole makes fluid-communication with the reservoir tank, the spool includes a first portion which slides through an inner wall of the sleeve, a second portion which slides through an inner wall of the sleeve, and a third portion formed between the first and second portions, the third portion has an outer diameter smaller than outer diameters of the first and second portions, the third portion has such a length extending in an axial direction of the spool that neither the first sleeve through-hole nor the second sleeve through-hole is not allowed to make fluid-communication with the third sleeve hole, a gap defining a fluid path through which the hydraulic fluid flows is formed along at least a part of the spool at an area in which the first sleeve through-hole and the through-hole intersect with each other, and a gap defining a fluid path through which the hydraulic fluid flows is formed along at least a part of the spool at an area in which the second sleeve through-hole and the through-hole intersect with each other, and the spool moves in such a stroke that the third portion allows one of the first and second sleeve through-holes to make fluid-communication with the third sleeve hole or does not allow both of the first and second sleeve through-holes to make fluid-communication with the third sleeve hole.

It is preferable that the gap is formed as an annular groove having an inner diameter greater than an outer diameter of the spool.

It is preferable that the sleeve is formed with at least three holes leading into the through-hole in correspondence with the first portion of the spool, the sleeve operates such that first one of the three holes makes fluid-communication with the head-sided hydraulic chamber of the hydraulic cylinder, second one of the three holes makes fluid-communication with the hydraulic pump, and the rest of the three holes is closed, the sleeve is formed with at least three holes leading into the through-hole in correspondence with the second portion of the spool, and the sleeve operates such that first one of the three holes makes fluid-communication with the rod-sided hydraulic chamber of the hydraulic cylinder, second one of the three holes makes fluid-communication with the hydraulic pump, and the rest of the three holes is closed.

For instance, the servo-valve may be designed to include a sleeve formed with a through-hole, and a spool slidable through an inner wall of the through-hole, in which case, it is preferable that the sleeve is formed with a first sleeve through-hole through which the head-sided hydraulic chamber of the hydraulic cylinder makes fluid-communication with one of the inlet and the outlet of the hydraulic pump, a second sleeve through-hole through which the rod-sided hydraulic chamber of the hydraulic cylinder makes fluid-communication with the other, and a third sleeve hole through which the through-hole makes fluid-communication with the reservoir tank, the spool includes a first portion which slides through an inner wall of the sleeve, a second portion which slides through an inner wall of the sleeve, and a third portion formed between the first and second portions, the third portion has an outer diameter smaller than outer diameters of the first and second portions, the third portion has such a length extending in an axial direction of the spool that neither the first sleeve through-hole nor the second sleeve through-hole is not allowed to make fluid-communication with the third sleeve hole, the first portion is formed with a first annular groove making fluid-communication with the first sleeve through-hole, and second portion is formed with a second annular groove making fluid-communication with the second sleeve through-hole, and the spool moves in such a stroke that the third portion allows one of the first and second sleeve through-holes to make fluid-communication with the third sleeve hole or does not allow both of the first and second sleeve through-holes to make fluid-communication with the third sleeve hole.

It is preferable that the first sleeve through-hole has an inner diameter different from an inner diameter of the second sleeve through-hole.

It is preferable that the third sleeve hole is situated in a length-wise direction of the servo-valve between the first sleeve through-hole and the second sleeve through-hole.

It is preferable that the third sleeve hole has an inner diameter smaller than inner diameters of the first and second sleeve through-holes.

For instance, the servo-valve may be designed to include a sleeve formed with a through-hole, and a spool slidable through an inner wall of the through-hole, in which case, it is preferable that the sleeve is formed with a first sleeve hole through which the head-sided hydraulic chamber of the hydraulic cylinder makes fluid-communication with the through-hole, a second sleeve hole through which the rod-sided hydraulic chamber of the hydraulic cylinder makes fluid-communication with the through-hole, and a third sleeve hole through which the through-hole makes fluid-communication with the reservoir tank, the spool includes a first portion which slides through an inner wall of the sleeve, a second portion which slides through an inner wall of the sleeve, and a third portion formed between the first and second portions, the third portion has an outer diameter smaller than outer diameters of the first and second portions, the third portion has such a length extending in an axial direction of the spool that neither the first sleeve through-hole nor the second sleeve through-hole is not allowed to make fluid-communication with the third sleeve hole, and the spool moves in such a stroke that the third portion allows one of the first and second sleeve through-holes to make fluid-communication with the third sleeve hole or does not allow both of the first and second sleeve through-holes to make fluid-communication with the third sleeve hole.

It is preferable that the first sleeve hole has an inner diameter different from an inner diameter of the second sleeve hole.

It is preferable that the third sleeve hole is situated in a length-wise direction of the servo-valve between the first sleeve hole and the second sleeve hole.

For instance, the servo-valve may be designed to include a sleeve formed with a through-hole, and a spool slidable through an inner wall of the through-hole, in which case, it is preferable that the sleeve is formed with a first sleeve hole through which the head-sided hydraulic chamber of the hydraulic cylinder makes fluid-communication with the through-hole, a second sleeve hole through which the rod-sided hydraulic chamber of the hydraulic cylinder makes fluid-communication with the through-hole, and a third sleeve hole through which the through-hole makes fluid-communication with the reservoir tank, the spool is formed at an outer surface thereof with at least one notch, the notch has such a size that one of the first sleeve hole and the second sleeve hole is allowed to make fluid-communication with the third sleeve hole or neither the first sleeve hole nor the second sleeve hole is allowed to make fluid-communication with the third sleeve hole in accordance with a rotation degree of the spool.

It is preferable that the third sleeve hole is situated intermediate between the first and second sleeve holes.

It is preferable that the servo-valve varies a degree at which one of the head-sided hydraulic chamber and the rod-sided hydraulic chamber makes fluid-communication with the reservoir tank, to a designated degree.

It is preferable that the servo-valve varies the degree in accordance with any one or more of a revolution number of one of the electric motor and the hydraulic pump, a torque of one of the electric motor and the hydraulic pump, a rotational acceleration of one of the electric motor and the hydraulic pump, and a hydraulic pressure in one of the head-sided hydraulic chamber and the rod-sided hydraulic chamber.

It is preferable that the apparatus further includes a pressure controller for maintaining a hydraulic pressure of the hydraulic fluid contained in the reservoir tank to be equal to or greater than a positive hydraulic pressure not smaller than an absolute value of a maximum negative pressure generated in the apparatus.

### Advantages Provided by the Invention

The apparatus for electrically and hydraulically driving a hydraulic cylinder, in accordance with the present invention, makes it possible to control an opening degree (a degree at which the servo-valve causes the head-sided hydraulic chamber or the rod-sided hydraulic chamber of the hydraulic cylinder to make fluid-communication with the reservoir tank) of the servo-valve to a desired degree. Thus, it is possible to maintain flow rates and pressure balance in the head-sided hydraulic chamber and the rod-sided hydraulic chamber of the hydraulic cylinder in a good condition in accordance with an operation of the apparatus. As a result, it is possible to control a target speed and a target work volume of the hydraulic cylinder at a high speed.

Furthermore, the apparatus for electrically and hydraulically driving a hydraulic cylinder, in accordance with the present invention, provides the following advantages in comparison with the conventional electric-hydraulic hybrid driver.

The first advantage is that it is possible to shorten a response-delay time defined as a time having passed after an apparatus receives a start signal until the apparatus actually starts its operation.

Since the conventional electric-hydraulic hybrid driver 2000 is not able to control a difference in a flow rate of hydraulic fluid between the head-sided hydraulic chamber and the rod-sided hydraulic chamber until the head-sided electromagnetic valve 2100 or the rod-sided electromagnetic valve 2200 is open or closed, a response-delay time cannot avoid from being long. In contrast, since the apparatus in accordance with the present invention can readily control a flow rate difference of hydraulic fluid in accordance with a movement distance of the spool of the servo-valve, it is not possible to shorten a response-delay time.

The second advantage is that it is possible to control a flow rate of hydraulic fluid to a desired flow rate.

Since the control to the head-sided electromagnetic valve 2100 and the rod-sided electromagnetic valve 2200 in the conventional electric-hydraulic hybrid driver 2000 is simply on-off control, a flow rate of hydraulic fluid can be two flow rates accomplished when the head-sided electromagnetic valve 2100 or the rod-sided electromagnetic valve 2200 is on or off. In contrast, since the apparatus for electrically and hydraulically driving a hydraulic cylinder, in accordance with the present invention, makes it possible to vary a degree at which an inner space of the servo-valve makes fluid-communication with the first sleeve through-hole (or the first sleeve hole) or the second sleeve through-hole (or the second sleeve hole), into a desired degree, in accordance with a distance by which the spool of the servo-valve move, it is possible to control a flow rate of hydraulic fluid into a desired flow rate.

The third advantage is that occurrence of hunting can be almost completely prevented.

Since the pressure fluctuation resulted from opening and closing of the head-sided electromagnetic valve 2100 and the rod-sided electromagnetic valve 2200 was still high in the conventional electric-hydraulic hybrid driver 2000, it was impossible to completely prevent occurrence of hunting. In contrast, since the apparatus for electrically and hydraulically driving a hydraulic cylinder, in accordance with the present invention, makes it possible to vary a degree at which an inner space of the servo-valve makes fluid-communication with the first sleeve through-hole (or the first sleeve hole) or the second sleeve through-hole (or the second sleeve hole), into a desired degree, it is possible to smooth pressure fluctuation, and hence, it is possible to prevent occurrence of hunting caused by high pressure fluctuation.

The fourth advantage is that it is possible to prevent both heat generation and occurrence of cavitation.

There occurred heat generation in the electric motor 1100 and cavitation in the hydraulic pump 1200 due to the above-mentioned response-delay time and hunting in the conventional electric-hydraulic hybrid driver 2000. In contrast, since the apparatus for electrically and hydraulically driving a hydraulic cylinder, in accordance with the present invention, is able to shorten a response-delay time, and further, prevent occurrence of hunting, it is naturally possible to prevent heat generation and occurrence of cavitation.

### BRIEF DESCRIPTION OF THE DRAWINGS

FIG. 1 is a block diagram of the apparatus for electrically and hydraulically driving a hydraulic cylinder, in accordance with the first exemplary embodiment of the present invention.

FIG. 2 is a block diagram of the apparatus for electrically and hydraulically driving a hydraulic cylinder, in accordance with the first exemplary embodiment of the present invention, including a cross-sectional view of the servo-valve used in the apparatus.

FIG. 3 is a cross-sectional view of the servo-valve taken along the line III-III in FIG. 2.

FIG. 4 is a block diagram of the apparatus for electrically and hydraulically driving a hydraulic cylinder, in accordance with the first exemplary embodiment of the present invention, which drives the hydraulic cylinder such that the hydraulic cylinder works, that is, the rod pushes a load, including a cross-sectional view of the servo-valve.

FIG. 5 is a block diagram of the apparatus for electrically and hydraulically driving a hydraulic cylinder, in accordance with the first exemplary embodiment of the present invention, which drives the hydraulic cylinder such that the rod moves to the left, including a cross-sectional view of the servo-valve.

FIG. 6 is a view of waveforms showing the response performance of the conventional electric-hydraulic hybrid driver.

FIG. 7 is a view of waveforms showing the response performance of the apparatus for electrically and hydraulically driving a hydraulic cylinder, in accordance with the first exemplary embodiment of the present invention.

FIG. 8(A) is a view of a waveform of a step signal acting as an input control signal in the conventional electric-hydraulic hybrid driver, FIG. 8(B) is a view of a waveform of an operation of the cylinder, FIG. 8(C) is a view of a waveform of a revolution number of the electric motor, FIG. 8(D) is a view of a waveform indicating openings and closings of the first and second pilot check valves, FIG. 8(E) is a view of a waveform indicating a hydraulic pressure in the rod-sided hydraulic chamber of the cylinder, and FIG. 8(F) is a view of a waveform indicating a hydraulic pressure in the head-sided hydraulic chamber of the cylinder.

FIG. 9(A) is a view of a waveform of a step signal acting as an input control signal in the apparatus for electrically and hydraulically driving a hydraulic cylinder, in accordance with the first exemplary embodiment of the present invention, FIG. 9(B) is a view of a waveform of an operation of the cylinder, FIG. 9(C) is a view of a waveform of a revolution number of the electric motor, FIG. 9(D) is a view of a waveform indicating an operation of the servo-valve when it is at C-position (see FIG. 1), FIG. 9(E) is a view of a waveform indicating a hydraulic pressure in the rod-sided hydraulic chamber of the cylinder, and FIG. 9(F) is a view of a waveform indicating a hydraulic pressure in the head-sided hydraulic chamber of the cylinder.

FIG. 10 is a block diagram of an example of a system for controlling the apparatus for electrically and hydraulically driving a hydraulic cylinder, in accordance with the first exemplary embodiment of the present invention.

FIG. 11 is a block diagram of a modification of the apparatus for electrically and hydraulically driving a hydraulic cylinder, in accordance with the first exemplary embodiment of the present invention.

FIG. 12 is a cross-sectional view of a modification of the servo-valve in the first exemplary embodiment.

FIG. 13 is a cross-sectional view of the sleeve and the spool in the apparatus for electrically and hydraulically driving a hydraulic cylinder, in accordance with the second exemplary embodiment of the present invention.

FIG. 14 is a block diagram of the apparatus for electrically and hydraulically driving a hydraulic cylinder, in accordance with the third exemplary embodiment of the present invention, including a cross-sectional view of the servo-valve used in the apparatus.

FIG. 15 is a block diagram of the apparatus for electrically and hydraulically driving a hydraulic cylinder, in accordance with the third exemplary embodiment of the present invention, which drives the hydraulic cylinder such that the hydraulic cylinder works, that is, the rod pushes a load, including a cross-sectional view of the servo-valve.

FIG. 16 is a block diagram of the apparatus for electrically and hydraulically driving a hydraulic cylinder, in accordance with the third exemplary embodiment of the present invention, which drives the hydraulic cylinder such that the rod moves to the left, including a cross-sectional view of the servo-valve.

FIG. 17 is a block diagram of the apparatus for electrically and hydraulically driving a hydraulic cylinder, in accordance with the fourth exemplary embodiment of the present invention, including a cross-sectional view of the servo-valve used in the apparatus.

FIG. 18(A) is a front view of the servo-valve used in the fourth exemplary embodiment of the present invention, FIG. 18(B) is a side view of the servo-valve, and FIG. 18(C) is a cross-sectional view of the servo-valve.

FIG. 19 is a block diagram of the apparatus for electrically and hydraulically driving a hydraulic cylinder, in accordance with the fourth exemplary embodiment of the present invention, which drives the hydraulic cylinder such that the hydraulic cylinder works, that is, the rod pushes a load, and includes a cross-sectional view of the servo-valve.

FIG. 20 is a block diagram of the apparatus for electrically and hydraulically driving a hydraulic cylinder, in accordance with the fourth exemplary embodiment of the present invention, which drives the hydraulic cylinder such that the rod moves to the left, including a cross-sectional view of the servo-valve.

FIG. 21 is a cross-sectional view of a modification of the spool used in the fourth exemplary embodiment of the present invention.

FIG. 22 is a block diagram illustrating a structure of the conventional electric-hydraulic hybrid driver.

FIG. 23 is a block diagram illustrating a structure of the conventional electric-hydraulic hybrid driver.

### BEST EXEMPLARY EMBODIMENT FOR REDUCING THE INVENTION TO PRACTICE

### First Exemplary Embodiment

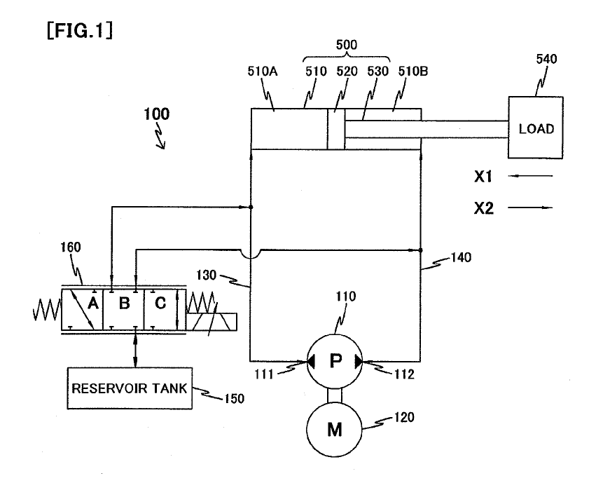

FIG. 1 is a block diagram of the apparatus 100 for electrically and hydraulically driving a hydraulic cylinder, in accordance with the first exemplary embodiment of the present invention.

As illustrated in FIG. 1, the apparatus 100 drives a hydraulic cylinder 500.

The hydraulic cylinder 500 includes a cylinder 510, a piston 520 slidable along an inner wall of the cylinder 510, and a rod 530 connected to the piston 520, and extending beyond the cylinder 510.

The rod 530 makes contact at a distal end thereof with a load 540.

When a hydraulic pressure in a head-sided hydraulic chamber 510A of the cylinder 510 is controlled to be higher than the same in a rod-sided hydraulic chamber 510B, the piston 520 and the rod 530 move to the right X2, and push the load 540 to the right X2. That is, the hydraulic cylinder 500 does a job to the load 540.

After the piston 520 and the rod 530 pushed the load 540 to a target position, a hydraulic pressure in the rod-sided hydraulic chamber 510B is set higher than the same in the head-sided hydraulic chamber 510A. As a result, the piston 520 and the rod 530 moves to the left X1 to an original position.

Thereafter, repeating the above-mentioned steps, the hydraulic cylinder 500 does a job to the load 540.

The apparatus 100 for electrically and hydraulically driving a hydraulic cylinder, in accordance with the first exemplary embodiment of the present invention, drives the hydraulic cylinder 500 such that the hydraulic cylinder 500 does a job to the load 540, by supplying hydraulic fluid (for instance, hydraulic oil) to the head-sided hydraulic chamber 510A and the rod-sided hydraulic chamber 510B of the cylinder 510 or by discharging hydraulic fluid out of the head-sided hydraulic chamber 510A and the rod-sided hydraulic chamber 510B

As illustrated in FIG. 1, the hybrid driving apparatus 100 in accordance with the first exemplary embodiment includes a hydraulic pump 110 rotatable in forward and backward directions, and having a first port 111 and a second port 112, an electric motor 120 rotating the hydraulic pump 110 in a forward or backward direction, a head-sided flow path 130 through which the head-sided hydraulic chamber 510A of the cylinder 510 and the first port 111 of the hydraulic pump 110 make fluid-communication with each other, a rod-sided flow path 140 through which the rod-sided hydraulic chamber 510B of the cylinder 510 and the second port 112 of the hydraulic pump 110 make fluid-communication with each other, a reservoir tank 150 reserving hydraulic fluid therein, and a servo-valve 160 capable of making fluid-communication with the head-sided flow path 130, the rod-sided flow path 140, and the reservoir tank 150, and taking three positions A, B and C (mentioned later).

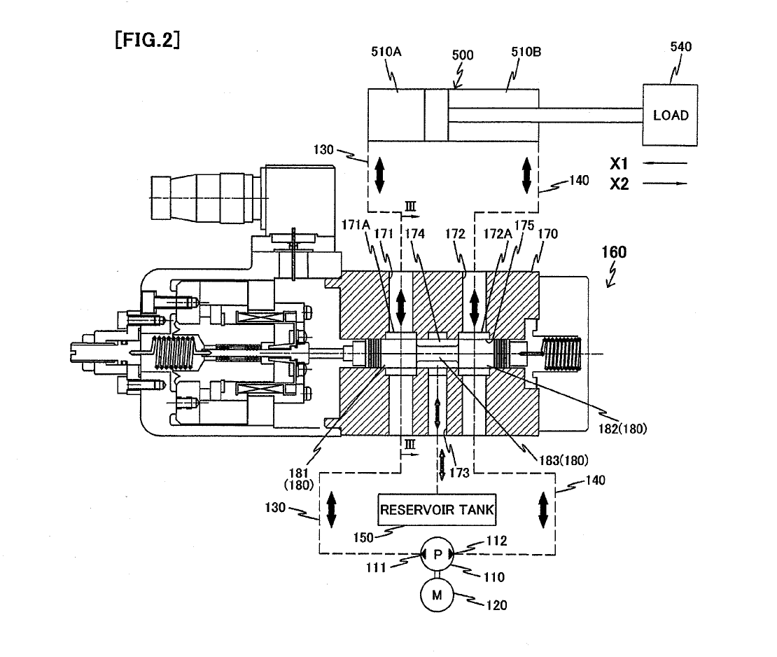

FIG. 2 is a block diagram of the hybrid driving apparatus 100 in accordance with the first exemplary embodiment of the present invention, including a cross-sectional view of the servo-valve 160.

As illustrated in FIG. 2, the servo-valve 160 includes a sleeve 170 formed therethrough a through-hole 175 extending in a length-wise direction (a left-right direction in FIG. 2) of the servo-valve 160, and a spool 180 slidable along an inner wall of the through-hole 175.

The sleeve 170 is formed with a first sleeve through-hole 171 intersecting with the through-hole 175 and passing through the sleeve 170 radially of the sleeve 170, a second sleeve through-hole 172 intersecting with the through-hole 175 and passing through the sleeve 170 radially of the sleeve 170, and a third sleeve hole 173 extending between the through-hole 175 and an outer surface of the sleeve 170.

The third sleeve 173 is situated intermediate between the first and second sleeve through-holes 171 and 172 in a length-wise direction of the servo-valve 160.

The first sleeve through-hole 171 has an inner diameter equal to the same of the second sleeve through-hole 172, and the third sleeve hole 173 has an inner diameter smaller than the same of the first and second sleeve through-holes 171 and 172.

As illustrated in FIG. 2, the head-sided hydraulic chamber 510A of the cylinder 510 makes fluid-communication with the first port 111 of the hydraulic pump 110 through both the head-sided flow path 130 and the first sleeve through-hole 171, and the rod-sided hydraulic chamber 510B of the cylinder 510 makes fluid-communication with the second port 112 of the hydraulic pump 110 through both the rod-sided flow path 140 and the second sleeve through-hole 172.

The reservoir tank 150 is in fluid-communication with the through-hole 175 of the sleeve 170 through the third through hole 173.

As illustrated in FIG. 2, the spool 180 includes a first portion 181 slidable along an inner wall of the through-hole 175 of the sleeve 170, a second portion 182 slidable along an inner wall of the through-hole 175 of the sleeve 170, and a third portion 183 formed between the first and second portions 181 and 182.

The first and second portions 181 and 182 have an outer diameter equal to an inner diameter of the through-hole 175. The third portion 183 has an outer diameter smaller than the same of the first and second portions 181 and 182. Thus, there is formed an inner space 174 between an inner wall of the through-hole 175 and an outer surface of the third portion 183.

The third portion 183 is designed to have such a length in an axial direction of the spool 180 that both the first and second sleeve through-holes 171 and 172 cannot make fluid-communication with the inner space 174 (that is, the reservoir tank 150).

Furthermore, the third sleeve hole 173 of the sleeve 170 is always situated within a stroke in which the third portion 183 can move. Specifically, the third sleeve hole 173 is situated so as to keep in facing relation with the third portion 183. Accordingly, the third sleeve hole 173 allows the reservoir tank 150 and the inner space 174 to keep in fluid-communication with each other.

Thus, as mentioned later, when the spool 180 moves to the left X1 in FIG. 2, the first sleeve through-hole 171 makes fluid-communication with the inner space 174, but the second sleeve through-hole 172 does not make fluid-communication with the inner space 174. When the spool 180 moves to the right X2 in FIG. 2, the second sleeve through-hole 172 makes fluid-communication with the inner space 174, but the first sleeve through-hole 171 does not make fluid-communication with the inner space 174.

Specifically, the servo-valve 160 allows one of the first and second sleeve through-holes 171 and 172 or one of the head-sided and rod-sided hydraulic chambers 501A and 510B of the cylinder 510 to make fluid-communication with the reservoir tank 150 through the inner space 174 and the third sleeve hole 173, or does not allow both the head-sided and rod-sided hydraulic chambers 501A and 510B of the cylinder 510 to make fluid-communication with the reservoir tank 150.

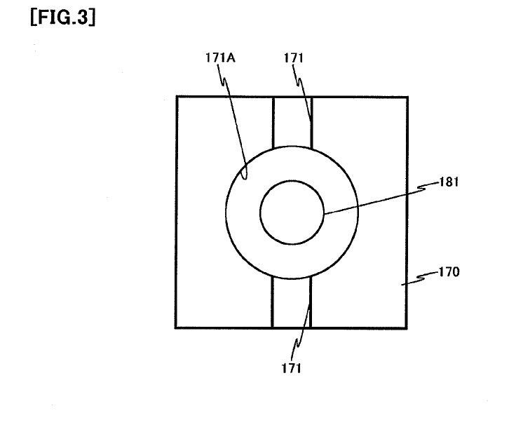

FIG. 3 is a cross-sectional view of the servo-valve 160, specifically, a cross-sectional view taken along the line III-III in FIG. 2.

There is formed a first annular groove 171A coaxially with the through-hole 175 of the sleeve 170 at an area where the through-hole 175 and the first sleeve through-hole 171 intersect with each other. Similarly, there is formed a second annular groove 172A coaxially with the through-hole 175 of the sleeve 170 at an area where the through-hole 175 and the second sleeve through-hole 172 intersect with each other.

The first annular groove 171A has an inner diameter greater than an outer diameter of the first portion 181 of the spool 180, and the second annular groove 172A has an inner diameter greater than an outer diameter of the second portion 182 of the spool 180.

The first portion 181 has a length greater than a width of the first annular groove 171A in a length-wise direction of the spool 180. Similarly, the second portion 182 has a length greater than a width of the second annular groove 172A in a length-wise direction of the spool 180.

The first annular groove 171A allows the head-sided hydraulic chamber 5010A to keep in fluid-communication with the first port 111 of the hydraulic pump 110 through the first sleeve through-hole 171 and the first annular groove 171A, even if the spool 180 moves to the right or left. Similarly, the second annular groove 172A allows the rod-sided hydraulic chamber 510B to keep in fluid-communication with the second port 112 of the hydraulic pump 110 through the second sleeve through-hole 172 and the second annular groove 172A, even if the spool 180 moves to the right or left.

As mentioned above, the spool 180 can take three positions A, B and C, as illustrated in FIG. 1.

When the spool 180 takes the position A, the head-sided hydraulic chamber 510A of the cylinder 510 is in fluid-communication with the reservoir tank 150, but the rod-sided hydraulic chamber 510B is not in fluid-communication with the reservoir tank 150.

When the spool 180 takes the position B, both of head-sided hydraulic chamber 510A and the rod-sided hydraulic chamber 510B of the cylinder 510 are not in fluid-communication with the reservoir tank 150.

When the spool 180 takes the position C, the rod-sided hydraulic chamber 510B of the cylinder 510 is in fluid-communication with the reservoir tank 150, but the head-sided hydraulic chamber 510A is not in fluid-communication with the reservoir tank 150.

The apparatus 100 in accordance with the first exemplary embodiment, having the above-mentioned structure, operates as follows.

In the condition illustrated in FIG. 2, hydraulic fluid keeps stationary without flowing in the apparatus 100, and accordingly, the rod 530 of the hydraulic cylinder 500 keeps stationary. In this condition, the spool 180 takes the position B.

Specifically, the head-sided hydraulic chamber 510A of the cylinder 510 is in fluid-communication with the first port 111 of the hydraulic pump 110 through the first sleeve through-hole 171 and the first annular groove 171A of the sleeve 170, and the rod-sided hydraulic chamber 510B of the cylinder 510 is in fluid-communication with the second port 112 of the hydraulic pump 110 through the second sleeve through-hole 172 and the second annular groove 172A of the sleeve 170.

The inner space 174 formed in the through-hole 175 of the sleeve 170 is in fluid-communication only with the reservoir tank 150 through the third sleeve hole 173, and is not in fluid-communication with the first and second sleeve through-holes 171 and 172.

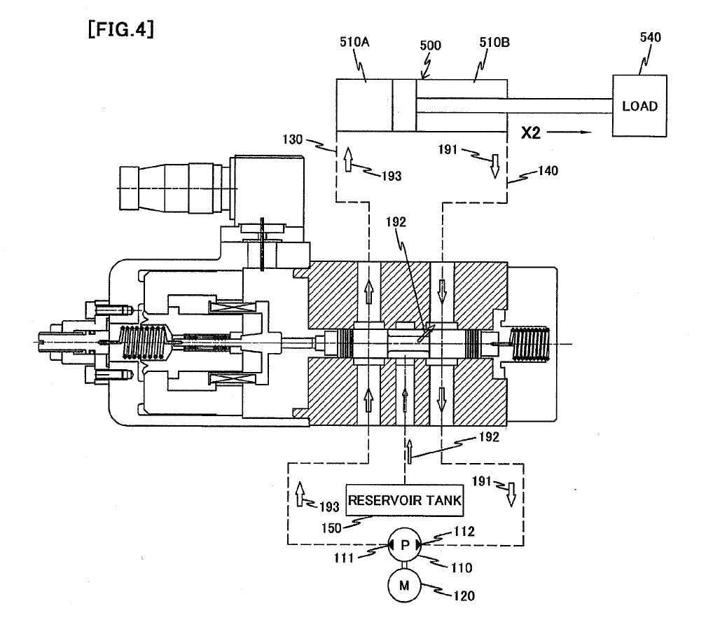

FIG. 4 is a block diagram of the apparatus 100 driving the hydraulic cylinder 500 to work, that is, driving the hydraulic cylinder 500 in the direction X2 in which the rod 530 pushes the load 540, including a cross-sectional view of the servo-valve 160.

When the rod 530 is caused to move in the direction X2 for pushing the load 540 from a stationary condition illustrated in FIG. 2, the hydraulic pump 110 is rotated in a forward direction by means of the electric motor 120, and further, as illustrated in FIG. 4, the spool 180 is moved to the right X2 from the position illustrated in FIG. 2, that is, the spool 180 is transferred to the position C from the position B.

When the hydraulic pump 110 rotates in a forward direction, hydraulic fluid is discharged out of the first port 111 of the hydraulic pump 110, and is absorbed into the hydraulic pump 110 through the second port 112. In other words, the first port 111 acts as an outlet port, and the second port 112 acts as an inlet port.

When the spool 180 is moved to the right X2, whereas the first sleeve through-hole 171 and the inner space 174 formed in the through-hole 175 is kept not in fluid-communication with each other, the second sleeve through-hole 172 is in fluid-communication with the inner space 174, and accordingly, in fluid-communication with the reservoir tank 150 through the third sleeve hole 173.

As shown with an arrow 191 in FIG. 4, hydraulic fluid existing in the rod-sided hydraulic chamber 510B of the cylinder 510 passes through the rod-sided flow path 140, the second sleeve through-hole 172 and the second annular groove 172A, and then, is absorbed into the hydraulic pump 110 through the second port 112.

When hydraulic fluid passes through the second sleeve through-hole 172, since the second sleeve through-hole 172 is in fluid-communication with the reservoir tank 150 through the inner space 174 and the third sleeve hole 173, hydraulic fluid reserved in the reservoir tank 150 is fed to the second sleeve through-hole 172, as shown with an arrow 192, due to a pressure difference between the second sleeve through-hole 172 and the third sleeve hole 173, and joins to hydraulic fluid flowing through the second sleeve through-hole 172.

Thus, hydraulic fluid having a volume equal to a difference between a volume of the head-sided hydraulic chamber 510A and a volume of the rod-sided hydraulic chamber 510B, that is, a volume equal to a volume of the rod 530 existing within the cylinder 510 is added to hydraulic fluid flowing through the second sleeve through-hole 172.

It is possible to control a degree at which the second sleeve through-hole 172 and the inner space 174 (and accordingly, the reservoir tank 150) make fluid-communication with each other, by controlling a distance at which the spool 180 moves to the right X2.

A distance at which the spool 180 moves can be controlled, for instance, in accordance with a position of the rod 530, a revolution number of the hydraulic pump 110 and/or the electric motor 120, a torque of the hydraulic pump 110 and/or the electric motor 120, a rotational acceleration of the hydraulic pump 110 and/or the electric motor 120, or a hydraulic pressure in the head-sided hydraulic chamber 510A and the rod-sided hydraulic chamber 510B, and so on.

Hydraulic fluid having been absorbed into the hydraulic pump 110 through the second port 112 is discharged towards the head-sided hydraulic chamber 510A of the cylinder 510 through the first port 111.

Hydraulic fluid having been discharged from the hydraulic pump 110 through the first port 111 is fed to the head-sided hydraulic chamber 510A of the cylinder 510 through the head-sided flow path 130 and the first sleeve through-hole 171, as shown with an arrow 193 in FIG. 4.

Thus, hydraulic fluid is continuously fed to the head-sided hydraulic chamber 510A from the rod-sided hydraulic chamber 510B through the hydraulic pump 110 and the servo-valve 160, and further, hydraulic fluid having a volume equal to a volume of the rod 530 existing in the cylinder 510 is added to hydraulic fluid to be fed to the head-sided hydraulic chamber 510A.

As a result, the rod 530 of the hydraulic cylinder 500 is caused to move to the right X2, and carries out a job of pushing the load 540 to the right X2.

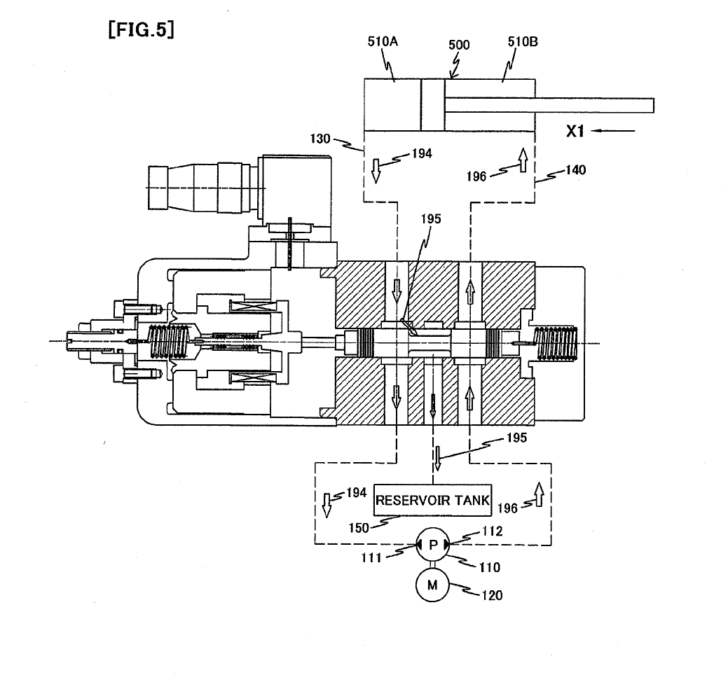

FIG. 5 is a block diagram of the apparatus 100 driving the hydraulic cylinder 500 such that the rod 530 moves to the left X1, including a cross-sectional view of the servo-valve 160.

In order to cause the rod 530 to move to the left X1, the hydraulic pump 110 is rotated by the electric motor 120 in a backward direction, and further, as illustrated in FIG. 5, the spool 180 is caused to move to the left X1 from the position illustrated in FIG. 2. That is, the spool 180 is transferred to the position A.

Causing the hydraulic pump 110 to rotate in a backward direction, hydraulic fluid is absorbed into the hydraulic pump 110 through the first port 111, and is discharged out of the hydraulic pump 110 through the second port 112. That is, the first port 111 acts as an inlet port, and the second port 112 acts as an outlet port.

When the spool 180 is moved to the left X1, whereas the second sleeve through-hole 172 and the inner space 174 are kept not in fluid-communication with each other, the first sleeve through-hole 171 is in fluid-communication with the inner space 174, and accordingly, in fluid-communication with the reservoir tank 150 through the third sleeve hole 173.

As shown with an arrow 194 in FIG. 5, hydraulic fluid existing in the head-sided hydraulic chamber 510A of the cylinder 510 passes through the head-sided flow path 130, the first sleeve through-hole 171 and the first annular groove 171A, and then, is absorbed into the hydraulic pump 110 through the first port 111.

When hydraulic fluid passes through the first sleeve through-hole 171, since the first sleeve through-hole 171 is in fluid-communication with the reservoir tank 150 through the inner space 174 and the third sleeve hole 173, a part of the hydraulic fluid is fed to the reservoir tank 150, as shown with an arrow 195, through the inner space 174 and the third sleeve hole 173.

Thus, hydraulic fluid having a volume equal to a difference between a volume of the head-sided hydraulic chamber 510A and a volume of the rod-sided hydraulic chamber 510B, that is, a volume equal to a volume of the rod 530 existing within the cylinder 510 is removed from hydraulic fluid flowing through the first sleeve through-hole 171.

Similarly to the control to a degree at which the second sleeve through-hole 172 and the inner space 174 are in fluid-communication with each other, it is possible to control a degree at which the first sleeve through-hole 171 and the inner space 174 (and accordingly, the reservoir tank 150) make fluid-communication with each other, by controlling a distance at which the spool 180 moves to the left X1. A distance at which the spool 180 moves can be controlled, for instance, in accordance with a position of the rod 530, a revolution number of the hydraulic pump 110 and/or the electric motor 120, a torque of the hydraulic pump 110 and/or the electric motor 120, a rotational acceleration of the hydraulic pump 110 and/or the electric motor 120, or a hydraulic pressure in the head-sided hydraulic chamber 510A and the rod-sided hydraulic chamber 510B, and so on.

Hydraulic fluid having been absorbed into the hydraulic pump 110 through the first port 111 is discharged towards the rod-sided hydraulic chamber 510B of the cylinder 510 through the second port 112.

Hydraulic fluid having been discharged from the hydraulic pump 110 through the second port 112 is fed to the rod-sided hydraulic chamber 510B of the cylinder 510 through the rod-sided flow path 140, the second sleeve through-hole 172 and the second annular groove 172A, as shown with an arrow 196 in FIG. 5.

Thus, hydraulic fluid is continuously fed into the rod-sided hydraulic chamber 510B from the head-sided hydraulic chamber 510A through the hydraulic pump 110 and the servo-valve 160, and further, a part of hydraulic fluid is fed into the reservoir tank 150.

As a result, the rod 530 of the hydraulic cylinder 500 is caused to move to the left X1.

As mentioned above, in the hybrid driving apparatus 100 in accordance with the first exemplary embodiment, the servo-valve 160 allows the head-sided hydraulic chamber 510A of the cylinder 510 to make fluid-communication with one of the first port 111 and the second port 112 of the hydraulic pump 110, allows the rod-sided hydraulic chamber 510B of the cylinder 510 to make fluid-communication with the other, and further, allows one of the head-sided hydraulic chamber 510A and the rod-sided hydraulic chamber 510B to make fluid-communication with the reservoir tank 150 in accordance with a rotational direction of the hydraulic pump 110, that is, a direction in which the rod 530 moves.

The hybrid driving apparatus 100 in accordance with the first exemplary embodiment provides the following advantages.

The first advantage is that it is possible to shorten a response-delay time found until the hybrid driving apparatus 100 starts its operation.

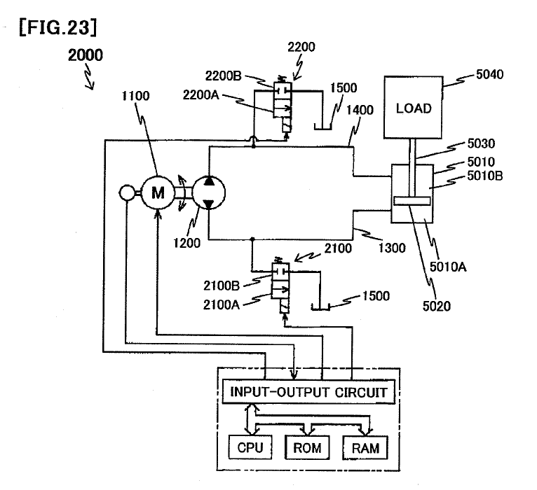

Since the conventional electric-hydraulic hybrid driver 2000 illustrated in FIG. 23 is not able to control a difference in a flow rate of hydraulic fluid between the head-sided hydraulic chamber 5010A and the rod-sided hydraulic chamber 5010B until the head-sided electromagnetic valve 2100 or the rod-sided electromagnetic valve 2200 is open or closed, a response-delay time could not avoid from being long. In contrast, since the hybrid driving apparatus 100 in accordance with the first exemplary embodiment can readily control a flow rate difference of hydraulic fluid in accordance with a movement distance of the spool 180, it is not possible to shorten a response-delay time.

The second advantage is that it is possible to control a flow rate of hydraulic fluid to a desired flow rate.

Since the control to the head-sided electromagnetic valve 2100 and the rod-sided electromagnetic valve 2200 in the conventional electric-hydraulic hybrid driver 2000 is simply on-off control, a flow rate of hydraulic fluid can be two flow rates accomplished when the head-sided electromagnetic valve 2100 or the rod-sided electromagnetic valve 2200 is on or off. In contrast, since the hybrid driving apparatus 100 in accordance with the first exemplary embodiment makes it possible to vary a degree at which the first sleeve through-hole 171 or the second sleeve through-hole 172 makes fluid-communication with the inner space 174 (the reservoir tank 150) into a desired degree, in accordance with a distance by which the spool 180 move, it is possible to continuously control a flow rate of hydraulic fluid into a desired flow rate.

The third advantage is that occurrence of hunting can be almost completely prevented.

Since the pressure fluctuation resulted from opening and closing of the head-sided electromagnetic valve 2100 and the rod-sided electromagnetic valve 2200 was still high in the conventional electric-hydraulic hybrid driver 2000, it was impossible to completely prevent occurrence of hunting. In contrast, since the hybrid driving apparatus 100 in accordance with the first exemplary embodiment makes it possible to vary a degree at which the first sleeve through-hole 171 or the second sleeve through-hole 172 makes fluid-communication with the inner space 174 (the reservoir tank 150) into a desired degree, into a desired degree, it is possible to smooth pressure fluctuation, and hence, it is possible to prevent occurrence of hunting caused by high pressure fluctuation.

The fourth advantage is that it is possible to prevent both heat generation and occurrence of cavitation.

There occurred heat generation in the electric motor 1100 and cavitation in the hydraulic pump 1200 due to the above-mentioned response-delay time and hunting in the conventional electric-hydraulic hybrid driver 2000. In contrast, since the hybrid driving apparatus 100 in accordance with the first exemplary embodiment is able to shorten a response-delay time, and further, prevent occurrence of hunting, it is naturally possible to prevent heat generation and occurrence of cavitation.

In addition, the hybrid driving apparatus 100 in accordance with the first exemplary embodiment has high response performance and high loyalty relative to the conventional electric-hydraulic hybrid driver 1000 illustrated in FIG. 22. The detail is explained hereinbelow.

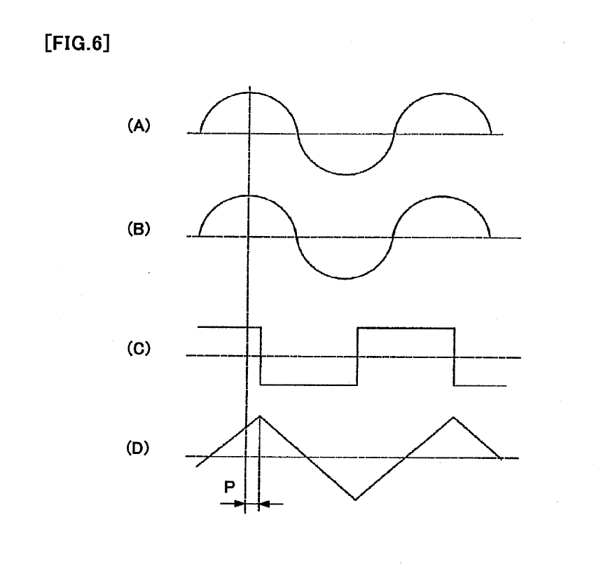

FIG. 6 is a view of waveforms showing the response performance of the conventional electric-hydraulic hybrid driver 1000.

Driving the electric motor 1100 in accordance with a sign-wave signal illustrated in FIG. 6(A) an an input control signal, the hydraulic pump 1200 works in accordance with a sign-wave signal, as illustrated in FIG. 6(B).

However, the first and second pilot check valves 1610 and 1620 cannot operate in accordance with the sign-wave signals illustrated in FIG. 6(A) and FIG. 6(B). A wave showing the operation of the first and second pilot check valves 1610 and 1620 is crank-shaped, as illustrated in FIG. 6(C).

Furthermore, a wave showing the operation of the hydraulic cylinder 5000 is not like the sign-waves illustrated in FIG. 6(A) and FIG. 6(B), but a triangular wave, as illustrated in FIG. 6(D).

In addition, the hydraulic cylinder 5000 cannot follow the sign-wave signal illustrated in FIG. 6(A) in operation. Thus, as illustrated in FIG. 6(D), there occurs a phase delay P relative to the sign-wave signals in a wave showing the operation of the hydraulic cylinder 5000.

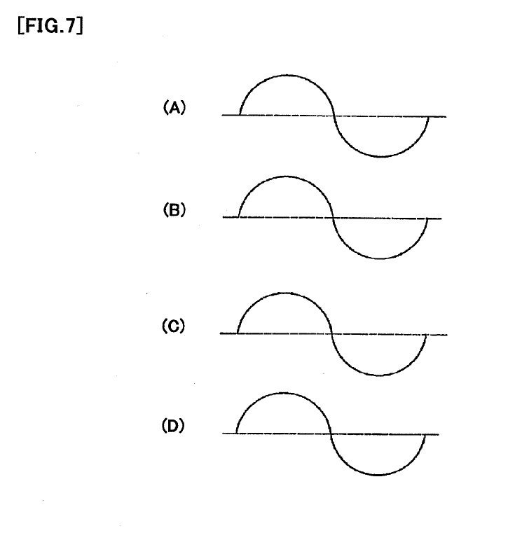

FIG. 7 is a view of waveforms showing the response performance of the hybrid driving apparatus 100 in accordance with the first exemplary embodiment.

Driving the electric motor 120 in accordance with a sign-wave signal illustrated in FIG. 7(A) an an input control signal, similarly to FIG. 6(A) and FIG. 6(B), the hydraulic pump 110 works in accordance with a sign-wave signal, as illustrated in FIG. 7(B).

The servo-valve 160 in the hybrid driving apparatus 100 in accordance with the first exemplary embodiment works accurately in accordance with the sign-wave signal illustrated in FIG. 7(A), as illustrated in FIG. 7(C).

Furthermore, as illustrated in FIG. 7(D), a wave showing the operation of the hydraulic cylinder 500 is identical with the sign-wave signal illustrated in FIG. 7(A).

In addition, there occurs, in the conventional electric-hydraulic hybrid driver 1000, a phase delay P relative to the sign-wave signals in a wave showing the operation of the hydraulic cylinder 5000. In contrast, there does not occur a phase delay P in a wave showing the operation of the hydraulic cylinder 500 in the hybrid driving apparatus 100 in accordance with the first exemplary embodiment.

As mentioned so far, in the hybrid driving apparatus 100 in accordance with the first exemplary embodiment, the hydraulic cylinder 500 operates with high response performance and high loyalty to an input control signal such as a sign-wave signal which is difficult to follow, unlike the conventional electric-hydraulic hybrid driver 1000.

Thus, the hybrid driving apparatus 100 in accordance with the first exemplary embodiment can have high response performance and high loyalty to an input control signal in comparison with the conventional electric-hydraulic hybrid driver 1000.

Hereinbelow is explained a difference in speed control to the hydraulic cylinder 500 in the case that there exist a load.

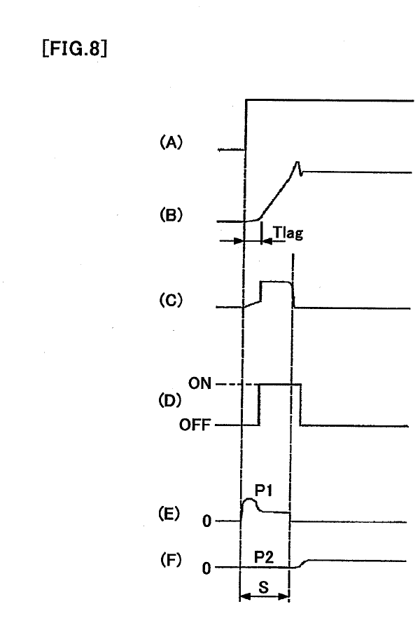

FIG. 8 is a view of waveforms for controlling a cylinder speed in the conventional electric-hydraulic hybrid driver 1000 illustrated in FIG. 22.

FIG. 8(A) is a view of a waveform of a step signal acting as an input control signal, FIG. 8(B) is a view of a waveform of an operation of the cylinder 5010, FIG. 8(C) is a view of a waveform of a revolution number of the electric motor 1100, FIG. 8(D) is a view of a waveform indicating openings and closings of the first and second pilot check valves, 1610 and 1620, FIG. 8(E) is a view of a waveform indicating a hydraulic pressure in the rod-sided hydraulic chamber 5010B of the cylinder 5010, and FIG. 8(F) is a view of a waveform indicating a hydraulic pressure in the head-sided hydraulic chamber 5010A of the cylinder 5010.

It is supposed in the conventional electric-hydraulic hybrid driver 1000 illustrated in FIG. 22 that the rod 5030 is to push a load at a distal end thereof, and the load pressurizes the rod 5030 towards the left X1. When the rod 5030 is intended to move to the left X1 the first pilot check valve 1610 is open to thereby allow a part of hydraulic fluid existing in the head-sided hydraulic chamber 5010A of the cylinder 5010 to flow into the tank 1500. In this operation, since the first pilot check valve 1610 is full open, and further, hydraulic pressure in the head-sided flow path 1300 leading to the head-sided hydraulic chamber 5010A is zero, even if hydraulic fluid is introduced into the rod-sided hydraulic chamber 5010B of the cylinder 5010, the load 5040 pressurizing the cylinder 5010 towards the left X1 exerts high influence to the cylinder 5010, resulting in that the hydraulic cylinder 5000 is merely able to carry out unstable operation, even if speed and position control is carried out to the cylinder 5010.

In the speed control range S illustrated in FIG. 8, since the operation of the cylinder 5010 is influenced by the load 5040, and accordingly, unstable.

Furthermore, since a pressure in the rod-sided flow path 1400 is influenced by the load 5040, the rod-sided flow path 1400 cannot keep its normal pressure therein.

In addition, a time lag caused when the first and second pilot check valves 1610 and 1620 are open or closed cannot avoid from being high, resulting in that the response performance of the conventional electric-hydraulic hybrid driver 1000 is deteriorated.

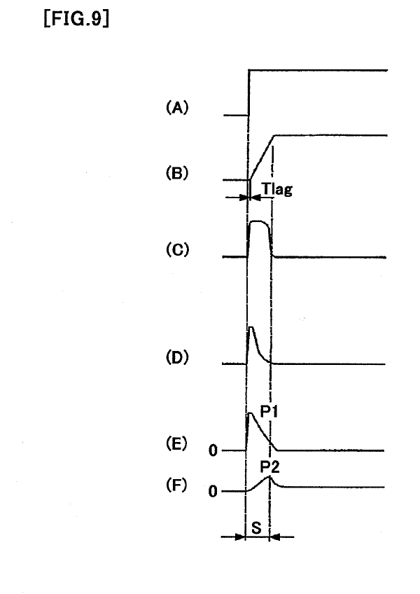

FIG. 9 is a view of waveforms for controlling a cylinder speed in the hybrid driving apparatus 100 in accordance with the first exemplary embodiment.

FIG. 9(A) is a view of a waveform of a step signal acting as an input control signal, FIG. 9(B) is a view of a waveform of an operation of the cylinder 510, FIG. 9(C) is a view of a waveform of a revolution number of the electric motor 110, FIG. 9(D) is a view of a waveform indicating the operation of the servo-valve 160 at the position C (see FIG. 1), FIG. 9(E) is a view of a waveform indicating a hydraulic pressure in the rod-sided hydraulic chamber 510B of the cylinder 510, and FIG. 9(F) is a view of a waveform indicating a hydraulic pressure in the head-sided hydraulic chamber 510A of the cylinder 510.

Similarly to FIG. 8, it is supposed that a load exerts the rod 530 at a distal end, and the load pressurizes the rod 5030 towards the left X1.

In the above-mentioned case, hydraulic fluid is fed to the rod-sided hydraulic chamber 510B from the head-sided hydraulic chamber 510A. The servo-valve 160 takes the position C (see FIG. 1) to thereby introduce a part of hydraulic fluid existing in the rod-sided hydraulic chamber 510B of the cylinder 510 into the reservoir tank 150.

At the position C of the servo-valve 160, for instance, in order to cancel a difference (a deviation signal) between a speed setting signal by which a predetermined speed of the rod 530 is indicated and a feedback speed signal indicating an actual speed of the rod 530, an opening degree of the servo-valve 160 at the position C is controlled in accordance with the deviation signal to thereby control an amount of hydraulic fluid fed back to the reservoir tank 150 from the rod-sided hydraulic chamber 510B. As a result, a hydraulic pressure in the rod-sided hydraulic chamber 510B corresponds to the load 540, and hence, it is possible to stably control a speed of the cylinder 510 with the hydraulic pressure in the rod-sided hydraulic chamber 510B acting as a brake.

Thus, the hybrid driving apparatus 100 in accordance with the first exemplary embodiment is able to stably control a moving speed of the rod 530 in comparison with the conventional electric-hydraulic hybrid driver 1000 illustrated in FIG. 22.

Hereinbelow is explained an example of the control to the hybrid driving apparatus 100 in accordance with the first exemplary embodiment.

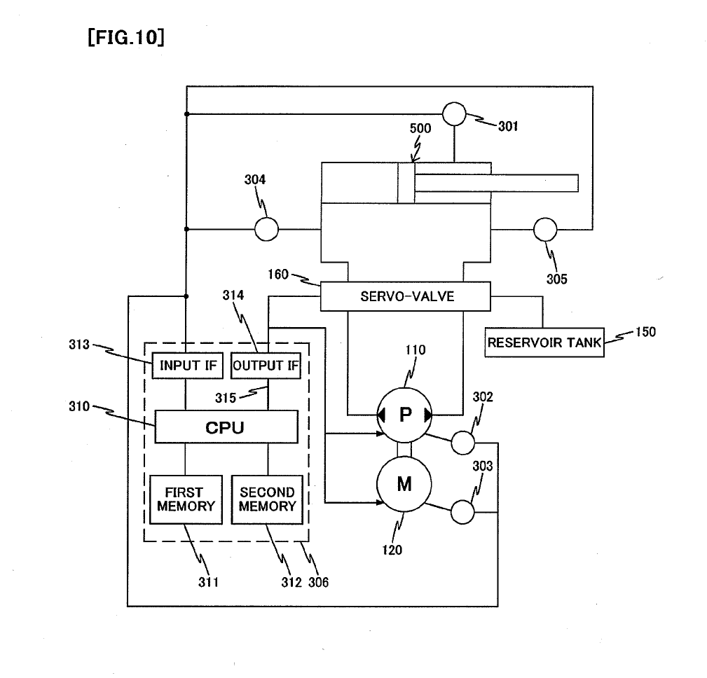

FIG. 10 is a block diagram of an example of a system for controlling the hybrid driving apparatus 100.

As illustrated in FIG. 10, the hybrid driving apparatus 100 in accordance with the first exemplary embodiment is designed to include, for controlling an operation thereof, a first sensor 301 detecting a position of the rod 530 in the cylinder 510, a second sensor 302 detecting at least one of a revolution number, a torque, and a rotational acceleration of the hydraulic pump 110, a third sensor 303 detecting at least one of a revolution number, a drive torque, and a rotational acceleration of the electric motor 120, a fourth sensor 304 detecting a pressure of hydraulic fluid in the head-sided flow path 130 (that is, a pressure in the head-sided hydraulic chamber 510A), a fifth sensor 305 detecting a pressure of hydraulic fluid in the rod-sided flow path 140 (that is, a pressure in the rod-sided hydraulic chamber 510B), and a control unit 306.

The control unit 306 is comprised of a central processing unit (CPU) 310, a first memory 311, a second memory 312, an input interface 313 through which commands and/or data are input into the central processing unit 310, an output interface 314 through which results of analysis having been executed by the central processing 310 unit is output, and buses 315 through which the central processing unit 310 are electrically connected to other parts.

Each of the first and second memories 311 and 312 is comprised of a semiconductor memory such as a read only memory (ROM), a random access memory (RAM) or an IC memory card, a storage device such as a flexible disc, a hard disc or an optic magnetic disc. In the first exemplary embodiment, the first memory 311 is comprised of ROM, and the second memory 312 is comprised of RAM.

The first memory 311 stores therein both various control programs to be executed by the central processing unit 310, and fixed data.

The second memory 312 stores therein various data and parameters, and presents a working area to the central processing unit 310. That is, the second memory 312 stores data which is temporarily necessary for the central processing unit 310 to execute programs.

The central processing unit 310 reads the program out of the first memory 311, and executes the program. Thus, the central processing unit 310 operates in accordance with the program stored in the first memory 311.

Data detected by the first to fifth sensors 301 to 305 is input into the input interface 313.

The input interface 313 transmits the received data to the central processing unit 310. The central processing unit 310 calculates a revolution number, a torque and/or a rotational acceleration of the hydraulic pump 110, a revolution number, a torque and/or a rotational acceleration of the electric motor 120, and an opening degree (a fluid-communication degree) of the servo-valve 160 suitable to the operation condition at that time, in accordance with formulas stored in the first memory 311.

The calculation results are transmitted to the hydraulic pump 110, the electric motor 120 and the servo-valve 160 through the output interface 314. The hydraulic pump 110, the electric motor 120 and the servo-valve 160 operate in accordance with the received signals. Thus, it is possible to optimally control a revolution number, a torque and a rotational acceleration of the hydraulic pump 110 and the electric motor 120, and an opening degree of the servo-valve 160.

The structure of the hybrid driving apparatus 100 in accordance with the first exemplary embodiment is not to be limited to the above-mentioned one, but may be varied as follows.

In the hybrid driving apparatus 100 in accordance with the first exemplary embodiment, the first sleeve through-hole 171 is designed to have an inner diameter equal to the same of the second sleeve through-hole 172. In accordance with a difference in a flow rate or a volume of the rod 530, the first sleeve through-hole 171 may be designed to have an inner diameter different from the same of the second sleeve through-hole 172.

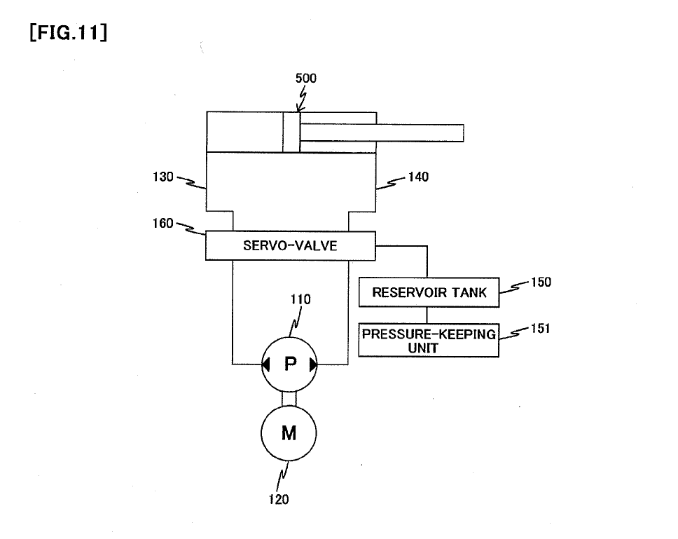

Furthermore, as illustrated in FIG. 11, the hybrid driving apparatus 100 in accordance with the first exemplary embodiment may be designed to further include a unit 151 for keeping a pressure of hydraulic fluid reserved in the reservoir tank 150 to be equal to or higher than a predetermined pressure.

As mentioned above, when the rod 530 is caused to move to the right X2, hydraulic fluid is caused to move to the head-sided hydraulic chamber 510B from the rod-sided hydraulic chamber 510B, in which case, as illustrated in FIG. 4, in order to compensate for a volume difference of the rod 530 existing in the cylinder 510, hydraulic fluid having a volume equal to the volume difference of the rod 530 is supplemented from the reservoir tank 150 to hydraulic fluid flowing in the second sleeve through-hole 172. This operation may result that a negative pressure is generated in the rod-sided flow path 140 (and the second sleeve through-hole 172), and hence, air mixed in the hydraulic fluid may be bubbled.

If the thus generated bubbles spread in the hydraulic fluid, an compression ratio of the hydraulic fluid is reduced from 0% to about 3% at maximum, resulting in deterioration in response performances of the hybrid driving apparatus 100.

The supposed maximum negative pressure is calculated in accordance with the following formula.

ΔP=(Q/(Cd×A))²×ρ/2
ΔP: Negative pressure [MPa]
Q: Maximum flow rate [cm³/sec]
A: Area of valve opening in spool [mm²]
Cd: Flow coefficient=0.6
ρ: Density of hydraulic fluid [kg/cm³]

For instance, when oil is used as hydraulic fluid, a density of the hydraulic fluid p is equal to 9×10⁻⁴. Supposing that a maximum flow rate Q is 54, and an area of valve opening A is 6.4, the negative pressure ΔP is −0.09 MPa. Accordingly, in order to prevent generation of a negative pressure, it is necessary for the pressure keeping unit 151 to keep a pressure of hydraulic fluid reserved in the reservoir tank 150 to be equal to or higher than 0.09 MPa, or 0.1 MPa if a margin is taken into consideration.

By keeping a pressure of hydraulic fluid reserved in the reservoir tank 150 to be equal to or higher than a predetermined pressure by means of the pressure keeping unit 151, it is possible to prevent generation of a negative pressure in the hybrid driving apparatus 100, and accordingly, prevent deterioration of response performance of the hybrid driving apparatus 100.

The electric motor 110 may be designed to be comprised of a servo-motor, in which case, a servo-driver controlling an operation of the servo-motor may be connected to a controller through periodic-response communication, and requisite data can be transmitted between the servo-driver and the controller.

Though the first and second annular grooves 171A and 172A in the hybrid driving apparatus 100 in accordance with the first exemplary embodiment are designed to be circular, it is not always necessary for them to be circular. All what is necessary is to form a gap sufficient to form a flow path for hydraulic fluid, around an entirety or a part of the spool 180, and thus, a semi-circular hole or a polygonal hole (for instance, a hexagonal hole) may be formed in place of the first and second annular grooves 171A and 172A, for instance.

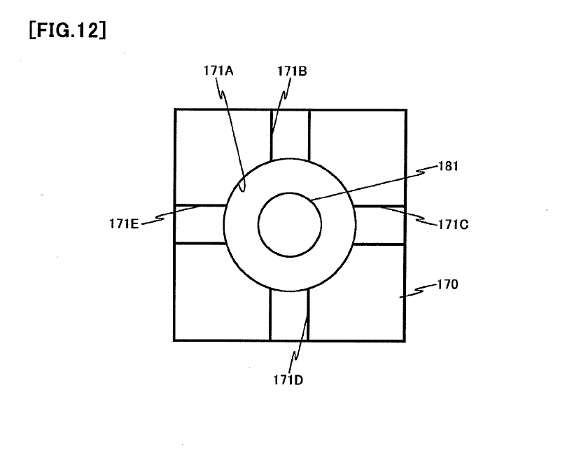

As illustrated in FIG. 3, the sleeve 170 is formed with the first sleeve through-hole 171 (or the second sleeve through-hole 172) as a path leading to the through-hole 175. For instance, as illustrated in FIG. 12, the sleeve 170 may be formed with four paths 171B, 171C, 171D and 171E all leading to the through-hole 175.

Any two paths may be used among the four paths in accordance with arrangement of the head-sided flow path 130 or the rod-sided flow path 140, or in accordance with arrangement of parts around the servo-valve 160. For instance, the paths 171B and 171D may be used (in which case, the path 171B is in fluid-communication with the head-sided hydraulic chamber 510A, and the path 171D is in fluid-communication with the hydraulic pump 110), and the paths 171C and 171E are closed, in which case, the sleeve has the same structure as the sleeve used in the hybrid driving apparatus 100 in accordance with the first exemplary embodiment. As an alternative, for instance, the paths 171B and 171E may be used (in which case, the path 171B is in fluid-communication with the head-sided hydraulic chamber 510A, and the path 171E is in fluid-communication with the hydraulic pump 110), and the paths 171C and 171D may be closed.

### Second Exemplary Embodiment

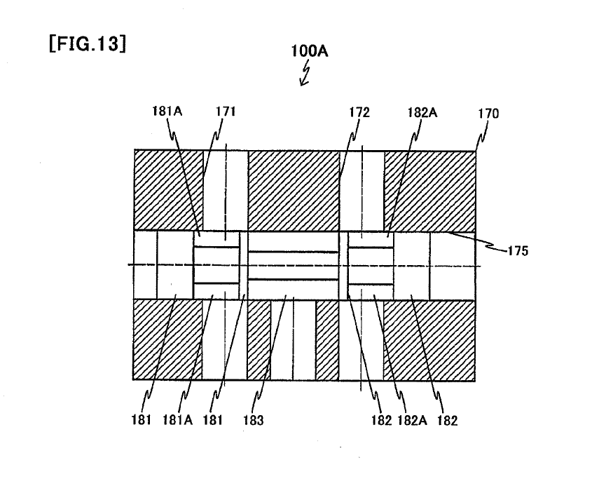

FIG. 13 is a cross-sectional view of the sleeve 170 and the spool 180 in the apparatus 100A for electrically and hydraulically driving a hydraulic cylinder, in accordance with the second exemplary embodiment of the present invention,

The hybrid driving apparatus 100A in accordance with the second exemplary embodiment is designed to include the first and second annular grooves 181A and 182A at the first and second portions 181 and 82 of the spool 180, respectively, in place of the first and second annular grooves 171A and 172A in comparison with the hybrid driving apparatus 100 in accordance with the first exemplary embodiment. Except this change, the hybrid driving apparatus 100A in accordance with the second exemplary embodiment has the same structure as that of the hybrid driving apparatus 100 in accordance with the first exemplary embodiment.

The first annular groove 181A can be formed by designing a part (not including opposite ends of the first portion 181) of the spool 180 in the length-wise direction thereof at the first portion 181 of the spool 180 to have an outer diameter smaller than an outer diameter of the first portion 181. Similarly, the second annular groove 182A can be formed by designing a part (not including opposite ends of the second portion 182) of the spool 180 in the length-wise direction thereof at the second portion 182 of the spool 180 to have an outer diameter smaller than an outer diameter of the second portion 182.

The first annular groove 181A has a length almost equal to an inner diameter of the first sleeve through-hole 171 in the length-wise direction of the spool 180, and the second annular groove 182A has a length almost equal to an inner diameter of the second sleeve through-hole 172 in the length-wise direction of the spool 180.

The first annular groove 181A formed in the first portion 181 is designed to keep in fluid-communication with the first sleeve through-hole 171, even if the spool 180 moves to the right or left, and similarly, the second annular groove 182A formed in the second portion 182 is designed to keep in fluid-communication with the second sleeve through-hole 172, even if the spool 180 moves to the right or left. Thus, the head-sided hydraulic chamber 5010A is always in fluid-communication with the first port 111 of the hydraulic pump 110, and similarly, the rod-sided hydraulic chamber 5010B is always in fluid-communication with the second port 112 of the hydraulic pump 110.

In the hybrid driving apparatus 100 in accordance with the first exemplary embodiment, the head-sided hydraulic chamber 510A of the cylinder 510 keeps in fluid-communication with the hydraulic pump 110 through the first sleeve through-hole 171 and the first annular groove 171A, and the rod-sided hydraulic chamber 510B of the cylinder 510 keeps in fluid-communication with the hydraulic pump 110 through the second sleeve through-hole 172 and the second annular groove 172A. In contrast, in the hybrid driving apparatus 100A in accordance with the second exemplary embodiment, the head-sided hydraulic chamber 510A of the cylinder 510 keeps in fluid-communication with the hydraulic pump 110 through the first sleeve through-hole 171 and the first annular groove 181A, and the rod-sided hydraulic chamber 510B of the cylinder 510 keeps in fluid-communication with the hydraulic pump 110 through the second sleeve through-hole 172 and the second annular groove 182A.

Thus, the hybrid driving apparatus 100A in accordance with the second exemplary embodiment can operate in the same way as the hybrid driving apparatus 100 in accordance with the first exemplary embodiment, and accomplish the same performances as those of the hybrid driving apparatus 100.

In addition, the first and second annular grooves 181A and 182A provide the advantage that hydraulic fluid exerts a uniform pressure onto the spool 180 in a circumferential direction of the spool 180.

### Third Exemplary Embodiment

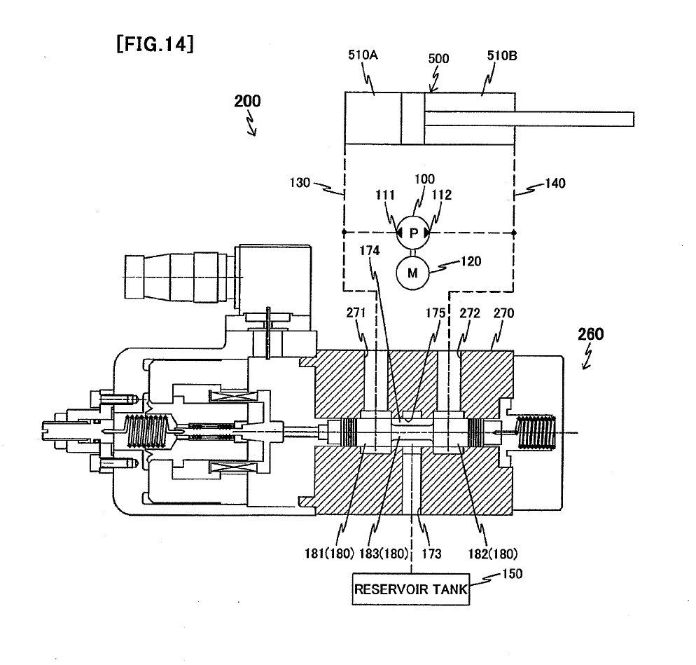

FIG. 14 is a block diagram of the apparatus 200 for electrically and hydraulically driving a hydraulic cylinder, in accordance with the third exemplary embodiment of the present invention, including a cross-sectional view of the servo-valve 260 used in the apparatus 200.

The hybrid driving apparatus 200 in accordance with the third exemplary embodiment is structurally different from the hybrid driving apparatus 100 in accordance with the first exemplary embodiment only in a structure of a sleeve.

Specifically, the sleeve 170 in the hybrid driving apparatus 100 in accordance with the first exemplary embodiment is designed to have the first and second sleeve through-holes 171 and 172 passing through the sleeve 170 radially of the sleeve 170, as illustrated in FIG. 2.

In contrast, the sleeve 270 in the hybrid driving apparatus 200 in accordance with the third exemplary embodiment is designed to have the first and second sleeve holes 271 and 272 extending to the through-hole 175 from an outer surface of the sleeve 270 radially of the sleeve 270, but not radially passing through the sleeve 270.

Except the above-mentioned difference, the hybrid driving apparatus 200 in accordance with the third exemplary embodiment has the same structure as that of the hybrid driving apparatus 100 in accordance with the first exemplary embodiment. Accordingly, parts that correspond to those of the first exemplary embodiment have been provided with the same reference numerals.

The hybrid driving apparatus 200 in accordance with the third exemplary embodiment, having the structure as mentioned above, operates as follows.

In the condition illustrated in FIG. 14, hydraulic fluid keeps stationary without flowing in the apparatus 200, and accordingly, the rod 530 of the hydraulic cylinder 500 keeps stationary. In this condition, the spool 280 takes the position B.

Specifically, the head-sided hydraulic chamber 510A of the cylinder 510 is in fluid-communication with the first port 111 of the hydraulic pump 110 through the head-sided flow path 130, but is shut out from the reservoir tank 150 by the first portion 181 of the spool 180. The rod-sided hydraulic chamber 510B of the cylinder 510 is in fluid-communication with the second port of the hydraulic pump 110 through the rod-sided flow path 140, but is shut out from the reservoir tank 150 by the second portion 182 of the spool 180.

Thus, the inner space 174 formed in the through-hole 175 of the sleeve 270 is in fluid-communication only with the reservoir tank 150 through the third sleeve hole 173, and is not in fluid-communication with the first and second sleeve holes 271 and 272.

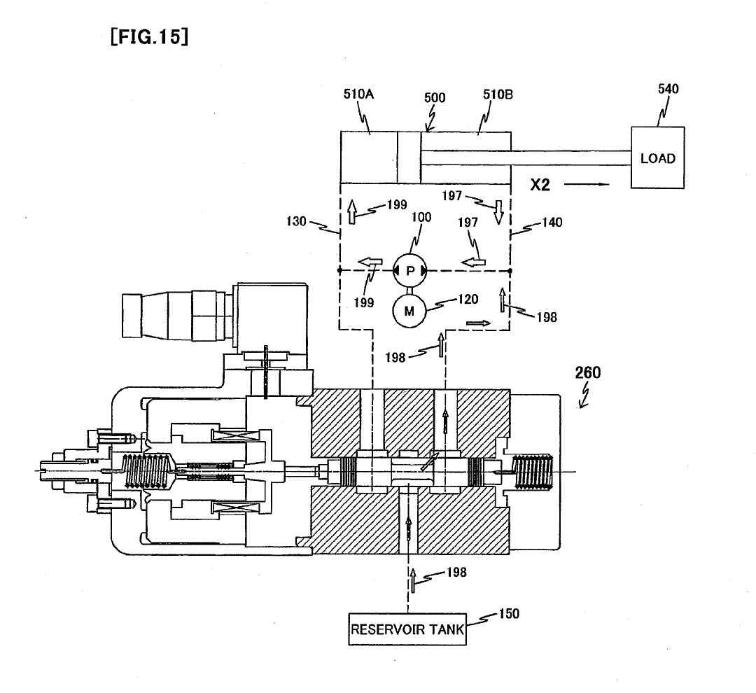

FIG. 15 is a block diagram of the apparatus 200 driving the hydraulic cylinder 500 to work, that is, driving the hydraulic cylinder 500 in the direction X2 in which the rod 530 pushes the load 540, including a cross-sectional view of the servo-valve 260.

When the rod 530 is caused to move in the direction X2 for pushing the load 540 from a stationary condition illustrated in FIG. 14, the hydraulic pump 110 is rotated in a forward direction by means of the electric motor 120, and further, as illustrated in FIG. 15, the spool 280 is moved to the right X2 from the position illustrated in FIG. 15, that is, the spool 180 is transferred to the position C from the position B.

When the hydraulic pump 110 rotates in a forward direction, hydraulic fluid is discharged out of the first port 111 of the hydraulic pump 110, and is absorbed into the hydraulic pump 110 through the second port 112. In other words, the first port 111 acts as an outlet port, and the second port 112 acts as an inlet port.

When the spool 180 is moved to the right X2, whereas the first sleeve hole 271 and the inner space 174 formed in the through-hole 175 is kept not in fluid-communication with each other, the second sleeve hole 272 is in fluid-communication with the inner space 174, and accordingly, in fluid-communication with the reservoir tank 150 through the third sleeve hole 273.

As shown with an arrow 197 in FIG. 15, hydraulic fluid existing in the rod-sided hydraulic chamber 510B of the cylinder 510 passes through the rod-sided flow path 140, and then, is absorbed into the hydraulic pump 110 through the second port 112.

When hydraulic fluid is absorbed into the hydraulic pump 110 through the rod-sided flow path 140, since the second sleeve hole 272 is in fluid-communication with the reservoir tank 150 through the inner space 174 and the third sleeve hole 273, hydraulic fluid reserved in the reservoir tank 150 is sucked into the second sleeve hole 172, as shown with an arrow 198, due to a pressure difference between the second sleeve hole 272 and the third sleeve hole 273, and joins to hydraulic fluid flowing through the rod-sided flow path 140.

Thus, hydraulic fluid having a volume equal to a difference between a volume of the head-sided hydraulic chamber 510A and a volume of the rod-sided hydraulic chamber 510B, that is, a volume equal to a volume of the rod 530 existing within the cylinder 510 is added to hydraulic fluid flowing through the rod-sided flow path 140.

It is possible to control a degree at which the second sleeve hole 272 and the inner space 174 (and accordingly, the reservoir tank 150) make fluid-communication with each other, by controlling a distance at which the spool 180 moves to the right X2. For instance, a distance at which the spool 180 moves can be controlled in the same way as the spool 180 in the first exemplary embodiment.

Hydraulic fluid having been absorbed into the hydraulic pump 110 through the second port 112 is discharged towards the head-sided hydraulic chamber 510A of the cylinder 510 through the first port 111.

Hydraulic fluid having been discharged from the hydraulic pump 110 through the first port 111 is fed to the head-sided hydraulic chamber 510A of the cylinder 510 through the head-sided flow path 130, as shown with an arrow 199 in FIG. 15.

Thus, hydraulic fluid is continuously fed to the head-sided hydraulic chamber 510A from the rod-sided hydraulic chamber 510B through the hydraulic pump 110, and further, hydraulic fluid having a volume equal to a volume of the rod 530 existing in the cylinder 510 is newly added to hydraulic fluid to be fed to the head-sided hydraulic chamber 510A from the reservoir tank 150.

As a result, the rod 530 of the hydraulic cylinder 500 is caused to move to the right X2, and carries out a job of pushing the load 540 to the right X2.

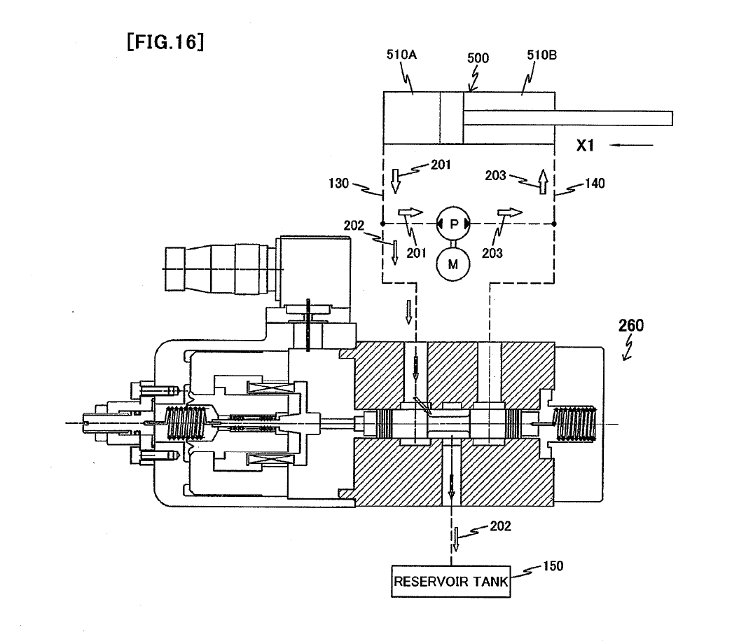

FIG. 16 is a block diagram of the apparatus 200 driving the hydraulic cylinder 500 such that the rod 530 moves to the left X1, including a cross-sectional view of the servo-valve 260.

In order to cause the rod 530 to move to the left X1, the hydraulic pump 110 is rotated by the electric motor 120 in a backward direction, and further, as illustrated in FIG. 16, the spool 180 is caused to move to the left X1 from the position illustrated in FIG. 12. That is, the spool 180 is transferred to the position A.

Causing the hydraulic pump 110 to rotate in a backward direction, hydraulic fluid is absorbed into the hydraulic pump 110 through the first port 111, and is discharged out of the hydraulic pump 110 through the second port 112. That is, the first port 111 acts as an inlet port, and the second port 112 acts as an outlet port.

When the spool 180 is moved to the left X1, whereas the second sleeve hole 272 and the inner space 174 are kept not in fluid-communication with each other, the first sleeve hole 271 is in fluid-communication with the inner space 174, and accordingly, in fluid-communication with the reservoir tank 150 through the third sleeve hole 173.

As shown with an arrow 201 in FIG. 16, hydraulic fluid existing in the head-sided hydraulic chamber 510A of the cylinder 510 passes through the head-sided flow path 130, and then, is absorbed into the hydraulic pump 110 through the first port 111.

When hydraulic fluid passes through the head-sided flow path 130, since the first sleeve hole 271 is in fluid-communication with the reservoir tank 150 through the inner space 174 and the third sleeve hole 173, a part of the hydraulic fluid is fed to the reservoir tank 150, as shown with an arrow 202, through the inner space 174 and the third sleeve hole 173.

Thus, hydraulic fluid having a volume equal to a difference between a volume of the head-sided hydraulic chamber 510A and a volume of the rod-sided hydraulic chamber 510B, that is, a volume equal to a volume of the rod 530 existing within the cylinder 510 is removed from hydraulic fluid flowing through the head-sided flow path 130.

Similarly to the control to a degree at which the second sleeve hole 272 and the inner space 174 make fluid-communication with each other, it is possible to control a degree at which the first sleeve hole 271 and the inner space 174 (and accordingly, the reservoir tank 150) make fluid-communication with each other, by controlling a distance at which the spool 180 moves to the left X1. For instance, a distance at which the spool 180 moves can be controlled in the same way as the spool 180 in the first exemplary embodiment.

Hydraulic fluid having been absorbed into the hydraulic pump 110 through the first port 111 is discharged towards the rod-sided hydraulic chamber 510B of the cylinder 510 through the second port 112.

Hydraulic fluid having been discharged from the hydraulic pump 110 through the second port 112 is fed to the rod-sided hydraulic chamber 510B of the cylinder 510 through the rod-sided flow path 140, as shown with an arrow 203 in FIG. 16.

Thus, hydraulic fluid is continuously fed into the rod-sided hydraulic chamber 510B from the head-sided hydraulic chamber 510A through the hydraulic pump 110, and further, a part of hydraulic fluid is fed into the reservoir tank 150 through the servo-valve 260

As a result, the rod 530 of the hydraulic cylinder 500 is caused to move to the left X1.

As mentioned above, in the hybrid driving apparatus 200 in accordance with the third exemplary embodiment, the hydraulic pump 110 allows the head-sided hydraulic chamber 510A and the rod-sided hydraulic chamber 510B to make fluid-communication with each other, and the servo-valve 260 allows one of the head-sided hydraulic chamber 510A and the rod-sided hydraulic chamber 510B to make fluid-communication with the reservoir tank 150 in accordance with a rotational direction of the hydraulic pump 120.

The hybrid driving apparatus 200 in accordance with the third exemplary embodiment provides the same advantages as those provided by the hybrid driving apparatus 100 in accordance with the first exemplary embodiment.

Similarly to the hybrid driving apparatus 100 in accordance with the first exemplary embodiment, the first sleeve hole 271 may be designed to have an inner diameter unequal to an inner diameter of the second sleeve hole 272 in the hybrid driving apparatus 200 in accordance with the third exemplary embodiment.

### Fourth Exemplary Embodiment

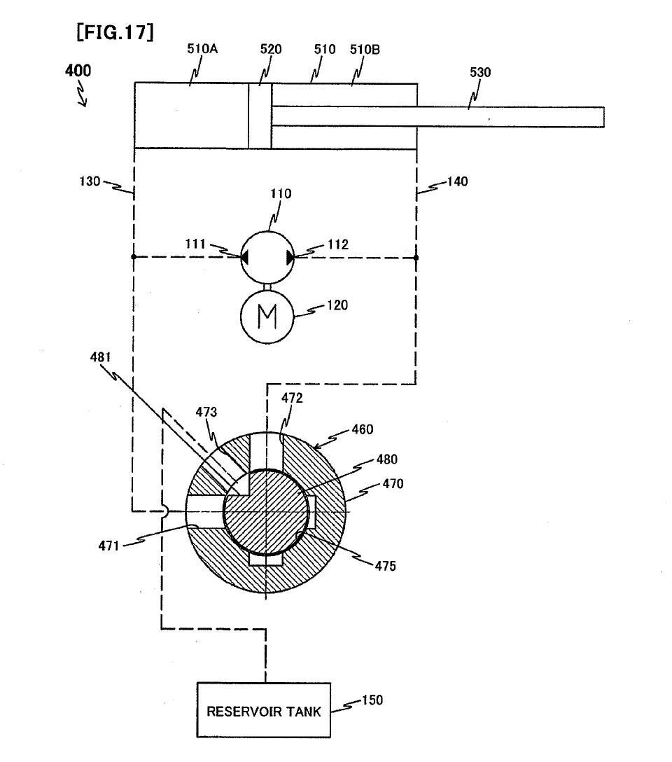

FIG. 17 is a block diagram of the apparatus 400 for electrically and hydraulically driving a hydraulic cylinder, in accordance with the fourth exemplary embodiment of the present invention, including a cross-sectional view of the servo-valve 460 used in the apparatus 400.

Similarly to the hybrid driving apparatus 100 in accordance with the first exemplary embodiment, the hybrid driving apparatus 400 in accordance with the fourth exemplary embodiment drives a hydraulic cylinder 500 (see FIG. 1).

As illustrated in FIG. 17, the hybrid driving apparatus 400 in accordance with the fourth exemplary embodiment includes a hydraulic pump 110 rotatable in forward and backward directions, and having a first port 111 and a second port 112, an electric motor 120 rotating the hydraulic pump 110 in a forward or backward direction, a head-sided flow path 130 through which the head-sided hydraulic chamber 510A of the cylinder 510 and the first port 111 of the hydraulic pump 110 make fluid-communication with each other, a rod-sided flow path 140 through which the rod-sided hydraulic chamber 510B of the cylinder 510 and the second port 112 of the hydraulic pump 110 make fluid-communication with each other, a reservoir tank 150 reserving hydraulic fluid therein, and a servo-valve 460 capable of making fluid-communication with the head-sided flow path 130, the rod-sided flow path 140, and the reservoir tank 150.

The hydraulic pump 110 is in fluid-communication with the head-sided flow path 130 through the first port 111, and further with the rod-sided flow path 140 through the second port 112. That is, the hydraulic pump 110 allows the head-sided hydraulic chamber 510A and the rod-sided hydraulic chamber 510B of the cylinder 510 to make fluid-communication with each other.

As mentioned later, the servo-valve 460 allows one of the head-sided hydraulic chamber 510A and the rod-sided hydraulic chamber 510B of the cylinder 510 to make fluid-communication with the reservoir tank 150 in accordance with a direction in which the hydraulic pump 110 rotates.

As illustrated in FIG. 17, the servo-valve 460 includes a cylindrical sleeve 470 formed with a through-hole 475 extending in a length-wise direction (a direction perpendicular to a sheet of FIG. 17) of the servo-valve 460, and a cylindrical spool 480 rotatable along an inner wall of the through-hole 475 of the sleeve 470.

The sleeve 470 is formed with a first sleeve hole 471 extending radially of the sleeve 470 to the through-hole 475, a second sleeve hole 472 extending radially of the sleeve 470 to the through-hole 475, and a third sleeve hole 473 extending radially of the sleeve 470 to the through-hole 475.

The first to third sleeves 471, 472 and 473 are designed not to interfere with one another.

The first and second sleeve holes 471 and 472 extend perpendicularly to each other. The third sleeve hole 473 is situated intermediate between the first and second sleeve holes 471 and 472.

The first sleeve hole 471 is designed to have an inner diameter equal to the same of the second sleeve hole 472, and the third sleeve hole 473 is designed to have an inner diameter smaller than the same of the first and second sleeve holes 471 and 472.

As illustrated in FIG. 17, the head-sided hydraulic chamber 510A of the cylinder 510 is in fluid-communication with the through-hole 475 through the first sleeve hole 471, and the rod-sided hydraulic chamber 510B of the cylinder 510 is in fluid-communication with the through-hole 275 through the second sleeve hole 472.

The reservoir tank 150 is in fluid-communication with the through-hole 475 of the sleeve 470 through the third sleeve hole 473.

As illustrated in FIG. 17, the spool 480 is formed at an outer surface thereof with a notch 481 having an almost triangular cross-section. The notch 481 is designed to have such a length (a length of a circular arc along a circumference of the spool 480) that the third sleeve hole 473 is not allowed to make fluid-communication with both of the first and second sleeve holes 471 and 472.

Thus, the spool 480 can take three positions A, B and C in accordance with a rotation angle thereof.

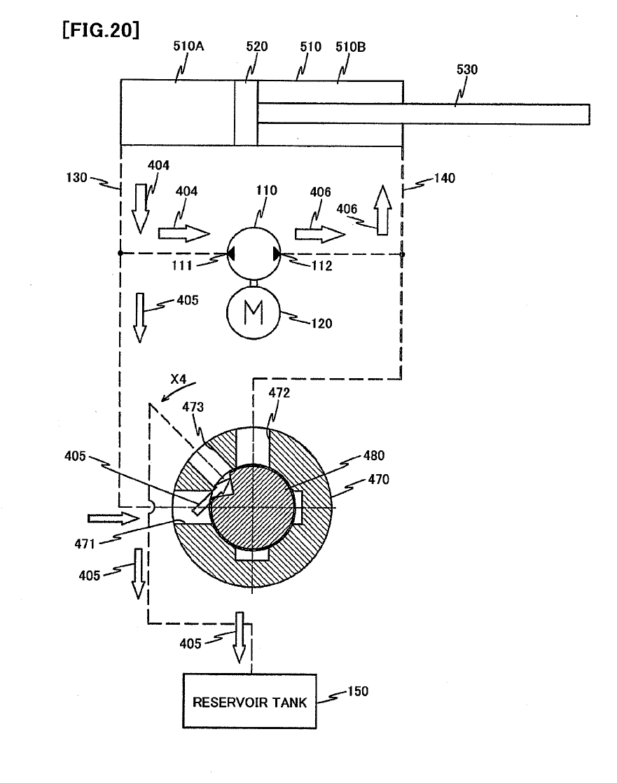

In the position A, the third sleeve hole 473 is in fluid-communication with the first sleeve hole 471 (see later-mentioned FIG. 20), in which case, the head-sided hydraulic chamber 510A of the cylinder 510 makes fluid-communication with the reservoir tank 150 through the head-sided flow path 130 and the servo-valve 460.

In the position B, the third sleeve hole 473 is not in fluid-communication with the first and second sleeve holes 471 and 472 (see FIG. 17), in which case, the head-sided hydraulic chamber 510A and the rod-sided hydraulic chamber 510B of the cylinder 510 do not make fluid-communication with the reservoir tank 150.

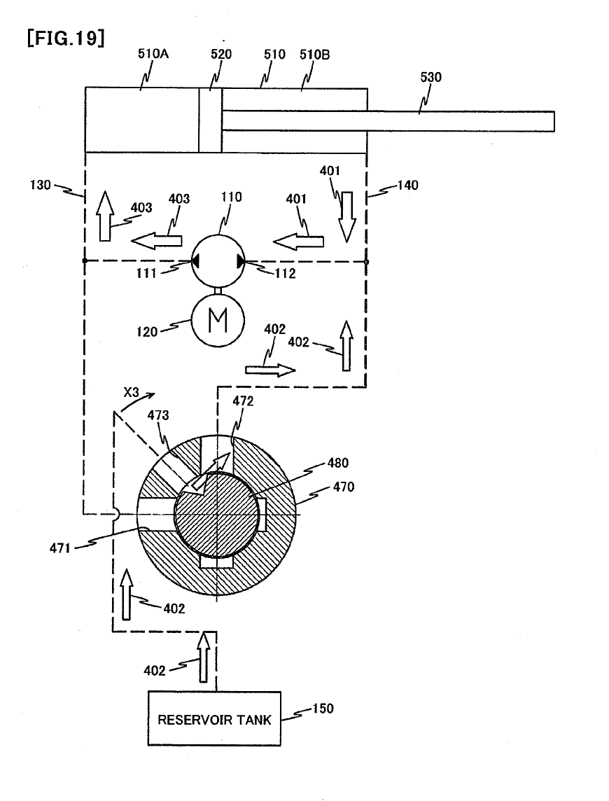

In the position C, the third and second sleeve holes 473 and 472 are in fluid-communication with each other through the notch 481 (see later-mentioned FIG. 19), in which case, the rod-sided hydraulic chamber 510B of the cylinder 510 makes fluid-communication with the reservoir tank 150 through the rod-sided flow path 140 and the servo-valve 460.

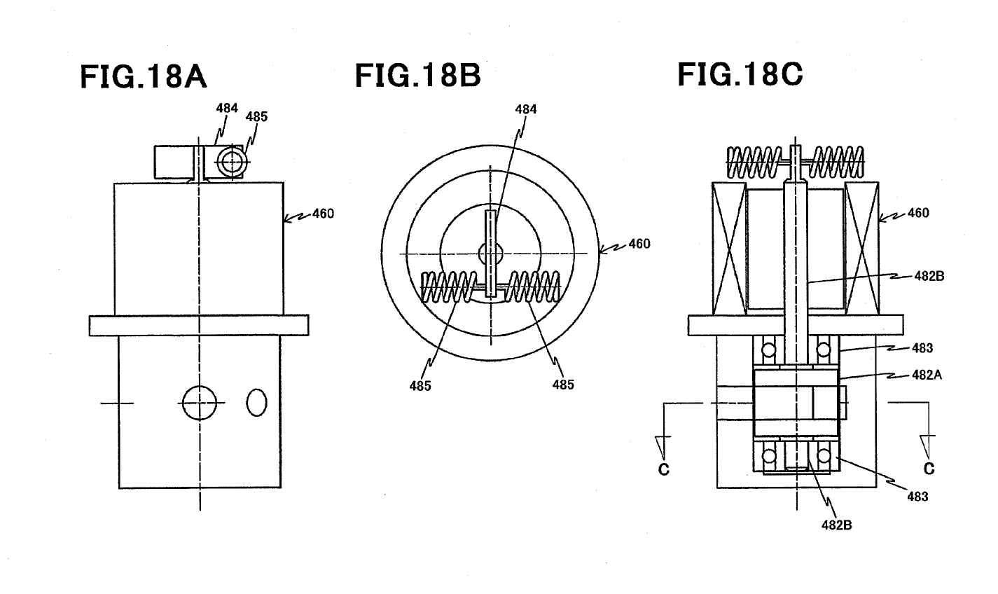

FIG. 18(A) is a front view of the servo-valve 460, FIG. 18(B) is a side view of the servo-valve 460, and FIG. 18(C) is a cross-sectional view of the servo-valve 460.

The cross-sectional view of the servo-valve 460 in FIG. 17 corresponds to a cross-sectional view taken along the line C-C in FIG. 18(C).

As illustrated in FIG. 18(C), the spool 480 is comprised of a cylindrical rotor 482A, and a shaft 482B extending from the rotor 482A.

The shaft 482B is coaxial with the rotor 482A, and has an outer diameter smaller than the same of the rotor 482A. The shaft 482B extends at opposite sides of the rotor 482A. Since the shaft 482B is supported in the sleeve 470 by means of a bearing 483, the spool 480 is wholly supported in the sleeve 470.

The rotor 482A rotates along an inner wall of the through-hole 475 of the sleeve 470.

The shaft 482B extends at an end thereof beyond the sleeve 470, and, as illustrated in FIG. 18(B), the shaft 482B is formed at the end with a plate 484. A pair of springs 485 is coupled to the plate 484. When one of the springs 484 pulls the plate 484, the spool 480 rotates accordingly.

A direction in which the spool 480 (specifically, the rotor 482A) rotates is defined by which one of the springs 485 pulls the plate 484, and an angle by which the spool 480 rotates is defined by a force by which the plate 484 is pulled. The spool 480 takes the above-mentioned position A, B or C in accordance with a rotational direction and a rotational angle.

The hybrid driving apparatus 400 in accordance with the fourth exemplary embodiment, having the above-mentioned structure, operates as follows.

In the condition illustrated in FIG. 17, hydraulic fluid keeps stationary without flowing in the apparatus 400, and accordingly, the rod 530 of the hydraulic cylinder 500 keeps stationary. In this condition, the spool 480 takes the position B.

Specifically, the head-sided hydraulic chamber 510A of the cylinder 510 is in fluid-communication with the first port 111 of the hydraulic pump 110 through the head-sided flow path 130, but is shut out from the reservoir tank 150 by the spool 480. The rod-sided hydraulic chamber 510B of the cylinder 510 is in fluid-communication with the second port 112 of the hydraulic pump 110 through the rod-sided flow path 140, but is shut out from the reservoir tank 150 by the spool 480.

In this condition, the reservoir tank 150 is in fluid-communication only with the third sleeve hole 473, and is not in fluid-communication with the first and second sleeve holes 471 and 472.

FIG. 19 is a block diagram of the apparatus 400 driving the hydraulic cylinder 500 to work, that is, driving the hydraulic cylinder 500 in the direction X2 in which the rod 530 pushes the load 540, including a cross-sectional view of the servo-valve 460.

When the rod 530 is caused to move in the direction X2 for pushing the load 540 from the stationary condition illustrated in FIG. 17, the hydraulic pump 110 is rotated in a forward direction by means of the electric motor 120, and further, as illustrated in FIG. 19, the rotor 482A of the spool 480 is rotated in a clock-wise direction X3 from the position illustrated in FIG. 17. That is, the spool 480 is transferred to the position C from the position B.

When the hydraulic pump 110 rotates in a forward direction, hydraulic fluid is discharged out of the first port 111 of the hydraulic pump 110, and is absorbed into the hydraulic pump 110 through the second port 112. In other words, the first port 111 acts as an outlet port, and the second port 112 acts as an inlet port.

By rotating the spool 480 in a clock-wise direction X3, whereas the first sleeve hole 471 and the third sleeve hole 473 (accordingly, the reservoir tank 150) keep shut out from each other in fluid-communication, the second sleeve hole 472 makes fluid-communication with the third sleeve hole 473 through the notch 481, and accordingly, makes fluid-communication with the reservoir tank 150 through the third sleeve hole 473.

As shown with an arrow 401 in FIG. 19, hydraulic fluid existing in the rod-sided hydraulic chamber 510B of the cylinder 510 passes through the rod-sided flow path 140, and then, is absorbed into the hydraulic pump 110 through the second port 112.

When hydraulic fluid is absorbed into the hydraulic pump 110 through the rod-sided flow path 140, since the second sleeve hole 472 is in fluid-communication with the reservoir tank 150 through the notch 481 and the third sleeve hole 473, hydraulic fluid reserved in the reservoir tank 150 is fed into the second sleeve hole 472, as shown with an arrow 402, due to a pressure difference between the second sleeve hole 472 and the third sleeve hole 473, and joins to hydraulic fluid flowing through the rod-sided flow path 140.

Thus, hydraulic fluid having a volume equal to a difference between a volume of the head-sided hydraulic chamber 510A and a volume of the rod-sided hydraulic chamber 510B, that is, a volume equal to a volume of the rod 530 existing within the cylinder 510 is added to hydraulic fluid flowing through the rod-sided flow path 140.

It is possible to control a degree at which the second sleeve hole 472 and the third sleeve hole 473 (and accordingly, the reservoir tank 150) make fluid-communication with each other, by controlling a rotation angle by which the spool 480 rotates in the clock-wise direction X3. For instance, a rotation angle by which the spool 480 rotates can be controlled in the same way as the spool 180 in the first exemplary embodiment.

Hydraulic fluid having been absorbed into the hydraulic pump 110 through the second port 112 is discharged towards the head-sided hydraulic chamber 510A of the cylinder 510 through the first port 111.

Hydraulic fluid having been discharged from the hydraulic pump 110 through the first port 111 is fed to the head-sided hydraulic chamber 510A of the cylinder 510 through the head-sided flow path 130, as shown with an arrow 403 in FIG. 19.

Thus, hydraulic fluid is continuously fed to the head-sided hydraulic chamber 510A from the rod-sided hydraulic chamber 510B through the hydraulic pump 110, and further, hydraulic fluid having a volume equal to a volume of the rod 530 existing in the cylinder 510 is newly added to hydraulic fluid to be fed to the head-sided hydraulic chamber 510A from the reservoir tank 150.

As a result, the rod 530 of the hydraulic cylinder 500 is caused to move to the right X2, and carries out a job of pushing the load 540 to the right X2.

FIG. 20 is a block diagram of the apparatus 400 driving the hydraulic cylinder 500 such that the rod 530 moves to the left X1, including a cross-sectional view of the servo-valve 460.

In order to cause the rod 530 to move to the left X1, the hydraulic pump 110 is rotated by the electric motor 120 in a backward direction, and further, as illustrated in FIG. 20, the spool 480 is caused to rotate in a counterclock-wise direction X4 from the position illustrated in FIG. 17. That is, the spool 480 is transferred to the position A.

Causing the hydraulic pump 110 to rotate in a backward direction, hydraulic fluid is absorbed into the hydraulic pump 110 through the first port 111, and is discharged out of the hydraulic pump 110 through the second port 112. That is, the first port 111 acts as an inlet port, and the second port 112 acts as an outlet port.

When the spool 480 rotates in the counterclock-wise direction X4, whereas the second sleeve hole 472 and the third sleeve hole 473 are kept not in fluid-communication with each other, the first sleeve hole 471 is in fluid-communication with the third sleeve hole 473 through the notch 481, and accordingly, in fluid-communication with the reservoir tank 150 through the third sleeve hole 473.

As shown with an arrow 404 in FIG. 20, hydraulic fluid existing in the head-sided hydraulic chamber 510A of the cylinder 510 passes through the head-sided flow path 130, and then, is absorbed into the hydraulic pump 110 through the first port 111.

When hydraulic fluid passes through the head-sided flow path 130, since the first sleeve hole 271 is in fluid-communication with the reservoir tank 150 through the notch 481 and the third sleeve hole 473, a part of the hydraulic fluid is fed to the reservoir tank 150, as shown with an arrow 405, through the notch 481 and the third sleeve hole 473.

Thus, hydraulic fluid having a volume equal to a difference between a volume of the head-sided hydraulic chamber 510A and a volume of the rod-sided hydraulic chamber 510B, that is, a volume equal to a volume of the rod 530 existing within the cylinder 510 is removed from hydraulic fluid flowing through the head-sided flow path 130.

Similarly to the control to a degree at which the second sleeve hole 472 and the third sleeve hole 473 make fluid-communication with each other, it is possible to control a degree at which the first sleeve hole 471 and the third sleeve hole 473 (and accordingly, the reservoir tank 150) make fluid-communication with each other, by controlling a rotation angle by which the spool 480 rotates in the counterclockwise direction X4. For instance, a rotation angle by which the spool 480 rotates can be controlled in the same way as the spool 180 in the first exemplary embodiment.

Hydraulic fluid having been absorbed into the hydraulic pump 110 through the first port 111 is discharged towards the rod-sided hydraulic chamber 510B of the cylinder 510 through the second port 112.

Hydraulic fluid having been discharged from the hydraulic pump 110 through the second port 112 is fed to the rod-sided hydraulic chamber 510B of the cylinder 510 through the rod-sided flow path 140, as shown with an arrow 406 in FIG. 20.

Thus, hydraulic fluid is continuously fed into the rod-sided hydraulic chamber 510B from the head-sided hydraulic chamber 510A through the hydraulic pump 110, and further, a part of hydraulic fluid is fed into the reservoir tank 150 through the servo-valve 260

As mentioned above, hydraulic fluid is continuously fed to the rod-sided hydraulic chamber 510B from the head-sided hydraulic chamber 510A of the cylinder 510 through the hydraulic pump 110, and further, a part of the hydraulic fluid is reserved in the reservoir tank 150 through the servo-valve 460.

As a result, the rod 530 of the hydraulic cylinder 500 is caused to move to the left X1.

As mentioned above, in the hybrid driving apparatus 400 in accordance with the fourth exemplary embodiment, the hydraulic pump 110 allows the head-sided hydraulic chamber 510A and the rod-sided hydraulic chamber 510B of the cylinder 510 to make fluid-communication with each other, and the servo-valve 460 allows one of the head-sided hydraulic chamber 510A and the rod-sided hydraulic chamber 510B to make fluid-communication with the reservoir tank 150 in accordance with a rotational direction of the hydraulic pump 120.

The hybrid driving apparatus 400 in accordance with the fourth exemplary embodiment provides the same advantages as those provided by the hybrid driving apparatus 100 in accordance with the first exemplary embodiment.

The structure of the hybrid driving apparatus 400 in accordance with the fourth exemplary embodiment is not to be limited to the above-mentioned structure, but may be varied as follows.

For instance, a number of the notch 481 is one (1) in the hybrid driving apparatus 400 in accordance with the fourth exemplary embodiment. As an alternative, the spool 480 may be designed to have two or more notches, and any one of them may be used.

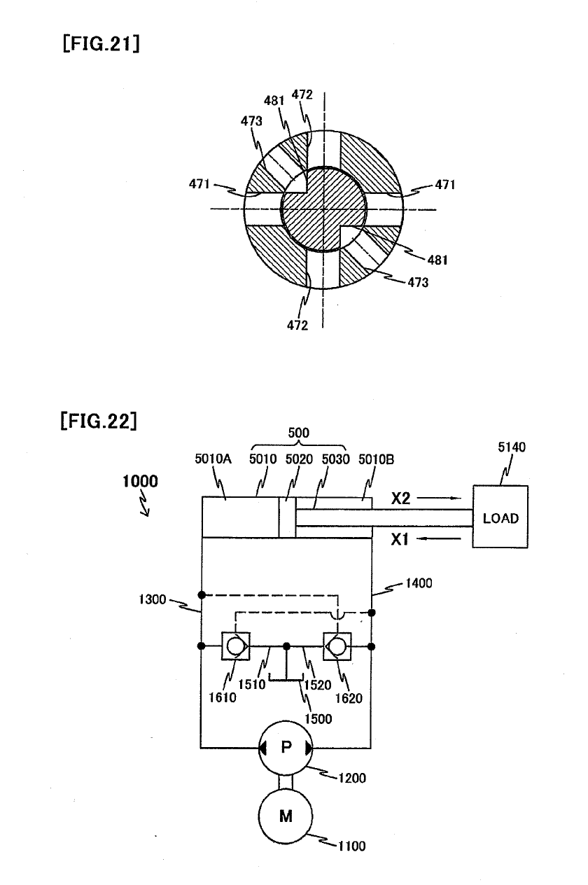

FIG. 21 is a cross-sectional view of a modification of the spool 480.

Though the spool 480 in the hybrid driving apparatus 400 in accordance with the fourth exemplary embodiment is designed to have the first to third sleeve holes 471, 472 and 473 all of which reach the through-hole 475, the first to third sleeve holes 471, 472 and 473 may be designed as a through-hole passing through the sleeve 470, as illustrated in FIG. 21, in which case, the spool 480 is designed to have two notches 481.

### INDICATION BY REFERENCE NUMERALS

100 Hybrid driving apparatus in accordance with the first exemplary embodiment
110 Hydraulic pump
120 Electric motor
130 Head-sided flow path
140 Rod-sided flow path
150 Reservoir tank
160 Servo-valve
170 Sleeve
171 First sleeve through-hole
171A First annular groove
172 Second sleeve through-hole
172A Second annular groove
173 Third sleeve hole
174 Inner space
175 Through-hole
180 Spool
181 First portion
182 Second portion
183 Third portion
100A Hybrid driving apparatus in accordance with the second exemplary embodiment
181A First annular groove
182A Second annular groove
200 Hybrid driving apparatus in accordance with the third exemplary embodiment
260 Servo-valve
270 Sleeve
271 First sleeve hole
272 Second sleeve hole
301 First sensor
302 Second sensor
303 Third sensor
304 Fourth sensor
305 Fifth sensor
306 Control unit
400 Hybrid driving apparatus in accordance with the fourth exemplary embodiment
460 Servo-valve
470 Sleeve
471 First sleeve hole
472 Second sleeve hole
473 Third sleeve hole
475 Through-hole
480 Spool
481 Notch
482A Rotor
482B Shaft
483 Bearing
500 Hydraulic cylinder
510 Cylinder
510A Head-sided hydraulic chamber
510B Rod-sided hydraulic chamber
520 Piston
530 Rod
540 Load

1. An apparatus for electrically and hydraulically driving a hydraulic cylinder, comprising:
a hydraulic pump rotatable in opposite directions;
an electric motor for driving said hydraulic pump;
a reservoir tank containing hydraulic fluid therein; and
a servo-valve,
wherein
said hydraulic cylinder makes fluid-communication at a head-sided hydraulic chamber with one of an inlet and an outlet of said hydraulic pump, and makes fluid-communication at a rod-sided hydraulic chamber with the other,
said servo-valve allows ones of said head-sided hydraulic chamber and said rod-sided hydraulic chamber to make fluid-communication to said reservoir tank in accordance with a direction in which said hydraulic pump rotates, and
said servo-valve varies a degree at which one of said head-sided hydraulic chamber and said rod-sided hydraulic chamber makes fluid-communication with said reservoir tank, to a designated degree.

2. The apparatus as set forth in claim 1, wherein said servo-valve comprises a sleeve formed with a through-hole, and a spool slidable through an inner wall of said through-hole,
said sleeve is formed with a first sleeve through-hole through which said head-sided hydraulic chamber of said hydraulic cylinder makes fluid-communication with one of said inlet and said outlet of said hydraulic pump, a second sleeve through-hole through which said rod-sided hydraulic chamber of said hydraulic cylinder makes fluid-communication with the other, and a third sleeve hole through which said through-hole makes fluid-communication with said reservoir tank,
said spool comprises a first portion which slides through an inner wall of said sleeve, a second portion which slides through an inner wall of said sleeve, and a third portion formed between said first and second portions,
said third portion has an outer diameter smaller than outer diameters of said first and second portions,
said third portion has such a length extending in an axial direction of said spool that neither said first sleeve through-hole nor said second sleeve through-hole is not allowed to make fluid-communication with said third sleeve hole,
a gap defining a fluid path through which said hydraulic fluid flows is formed along at least a part of said spool at an area in which said first sleeve through-hole and said through-hole intersect with each other, and a gap defining a fluid path through which said hydraulic fluid flows is formed along at least a part of said spool at an area in which said second sleeve through-hole and said through-hole intersect with each other, and
said spool moves in such a stroke that said third portion allows one of said first and second sleeve through-holes to make fluid-communication with said third sleeve hole or does not allow both of said first and second sleeve through-holes to make fluid-communication with said third sleeve hole.

3. The apparatus as set forth in claim 2, wherein said gap comprises an annular groove having an inner diameter greater than an outer diameter of said spool.

4. The apparatus as set forth in claim 2, wherein said sleeve is formed with at least three holes leading into said through-hole in correspondence with said first portion of said spool,
said sleeve operates such that first one of said three holes makes fluid-communication with said head-sided hydraulic chamber of said hydraulic cylinder, second one of said three holes makes fluid-communication with said hydraulic pump, and the rest of said three holes is closed,
said sleeve is formed with at least three holes leading into said through-hole in correspondence with said second portion of said spool, and
said sleeve operates such that first one of said three holes makes fluid-communication with said rod-sided hydraulic chamber of said hydraulic cylinder, second one of said three holes makes fluid-communication with said hydraulic pump, and the rest of said three holes is closed.

5. The apparatus as set forth in claim 1, wherein said servo-valve comprises a sleeve formed with a through-hole, and a spool slidable through an inner wall of said through-hole,
said sleeve is formed with a first sleeve through-hole through which said head-sided hydraulic chamber of said hydraulic cylinder makes fluid-communication with one of said inlet and said outlet of said hydraulic pump, a second sleeve through-hole through which said rod-sided hydraulic chamber of said hydraulic cylinder makes fluid-communication with the other, and a third sleeve hole through which said through-hole makes fluid-communication with said reservoir tank,
said spool comprises a first portion which slides through an inner wall of said sleeve, a second portion which slides through an inner wall of said sleeve, and a third portion formed between said first and second portions,
said third portion has an outer diameter smaller than outer diameters of said first and second portions,
said third portion has such a length extending in an axial direction of said spool that neither said first sleeve through-hole nor said second sleeve through-hole is not allowed to make fluid-communication with said third sleeve hole,
said first portion is formed with a first annular groove making fluid-communication with said first sleeve through-hole, and second portion is formed with a second annular groove making fluid-communication with said second sleeve through-hole, and
said spool moves in such a stroke that said third portion allows one of said first and second sleeve through-holes to make fluid-communication with said third sleeve hole or does not allow both of said first and second sleeve through-holes to make fluid-communication with said third sleeve hole.

6. The apparatus as set forth in claim 2, wherein said first sleeve through-hole has an inner diameter different from an inner diameter of said second sleeve through-hole.

7. The apparatus as set forth in claim 2, wherein said third sleeve hole is situated in a length-wise direction of said servo-valve between said first sleeve through-hole and said second sleeve through-hole.

8. The apparatus as set forth in claim 2, wherein said third sleeve hole has an inner diameter smaller than inner diameters of said first and second sleeve through-holes.

9. The apparatus as set forth in claim 1, wherein said servo-valve comprises a sleeve formed with a through-hole, and a spool slidable through an inner wall of said through-hole,
said sleeve is formed with a first sleeve hole through which said head-sided hydraulic chamber of said hydraulic cylinder makes fluid-communication with said through-hole, a second sleeve hole through which said rod-sided hydraulic chamber of said hydraulic cylinder makes fluid-communication with said through-hole, and a third sleeve hole through which said through-hole makes fluid-communication with said reservoir tank,
said spool comprises a first portion which slides through an inner wall of said sleeve, a second portion which slides through an inner wall of said sleeve, and a third portion formed between said first and second portions,
said third portion has an outer diameter smaller than outer diameters of said first and second portions,
said third portion has such a length extending in an axial direction of said spool that neither said first sleeve through-hole nor said second sleeve through-hole is not allowed to make fluid-communication with said third sleeve hole, and
said spool moves in such a stroke that said third portion allows one of said first and second sleeve through-holes to make fluid-communication with said third sleeve hole or does not allow both of said first and second sleeve through-holes to make fluid-communication with said third sleeve hole.

10. The apparatus as set forth in claim 9, wherein said first sleeve hole has an inner diameter different from an inner diameter of said second sleeve hole.

11. The apparatus as set forth in claim 9, wherein said third sleeve hole is situated in a length-wise direction of said servo-valve between said first sleeve hole and said second sleeve hole.

12. The apparatus as set forth in claim 1, wherein said servo-valve comprises a sleeve formed with a through-hole, and a spool slidable through an inner wall of said through-hole,
said sleeve is formed with a first sleeve hole through which said head-sided hydraulic chamber of said hydraulic cylinder makes fluid-communication with said through-hole, a second sleeve hole through which said rod-sided hydraulic chamber of said hydraulic cylinder makes fluid-communication with said through-hole, and a third sleeve hole through which said through-hole makes fluid-communication with said reservoir tank,
said spool is formed at an outer surface thereof with at least one notch,
said notch has such a size that one of said first sleeve hole and said second sleeve hole is allowed to make fluid-communication with said third sleeve hole or neither said first sleeve hole nor said second sleeve hole is allowed to make fluid-communication with said third sleeve hole in accordance with a rotation degree of said spool.

13. The apparatus as set forth in claim 12, wherein said third sleeve hole is situated intermediate between said first and second sleeve holes.

14. (canceled)

15. The apparatus as set forth in claim 1, wherein said servo-valve varies said degree in accordance with any one or more of a revolution number of one of said electric motor and said hydraulic pump, a torque of one of said electric motor and said hydraulic pump, a rotational acceleration of one of said electric motor and said hydraulic pump, and a hydraulic pressure in one of said head-sided hydraulic chamber and said rod-sided hydraulic chamber.

16. The apparatus as set forth in claim 1, further comprising means for maintaining a hydraulic pressure of said hydraulic fluid contained in said reservoir tank to be equal to or greater than a positive hydraulic pressure not smaller than an absolute value of a maximum negative pressure generated in said apparatus.
